(19) United States
(12) Patent Application Publication
(10) Pub. No.: US 2025/0227192 A1
(43) Pub. Date: Jul. 10, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: AKITOSHI YAMADA, Kanagawa (JP); MASAO KATO, Kanagawa (JP); KOUTA MURASAWA, Kanagawa (JP)

(21) Appl. No.: 19/013,998

(22) Filed: Jan. 8, 2025

(30) Foreign Application Priority Data
Jan. 10, 2024 (JP) 2024-002044
Oct. 3, 2024 (JP) 2024-174533

(51) Int. Cl. H04N 1/60; G06T 7/90; G06V 10/56

(52) U.S. Cl. CPC H04N 1/6066; G06T 7/90; G06V 10/56; G06T 2207/10024

(57) ABSTRACT

A receiving unit receives, from an apparatus configured to sequentially transmit respective divided images into which an image has been divided, a divided image. An obtaining unit obtains, from a first divided image received by the receiving unit, color information of a first color defined in a first color gamut and color information of a second color defined in the first color gamut. A conversion unit performs first color conversion processing for converting the first color into a third color defined in a second color gamut and converting the second color into a fourth color defined in the second color gamut. A first correction unit corrects the conversion parameter for the first color conversion processing. The obtaining unit, the conversion unit, and the first correction unit operate in response to the receiving unit receiving the divided image.

### BACKGROUND OF THE INVENTION

### Field of the Invention

The present invention relates to an information processing apparatus, an information processing method, and a storage medium.

### Description of the Related Art

Information processing apparatuses that receive a digital original described in a predetermined color space, map each color in that color space to a color gamut that can be reproduced by a printer, and output the result are known. Japanese Patent Laid-Open No. 2020-27948 describes “perceptual” mapping and “absolute colorimetric” mapping. In addition, Japanese Patent Laid-Open No. H07-203234 describes determining whether to compress the color space and the direction of compression for inputted color image signals.

### SUMMARY OF THE INVENTION

According to one embodiment of the present invention, an information processing apparatus comprises: a receiving unit configured to receive, from an apparatus configured to sequentially transmit respective divided images into which an image has been divided, a divided image; an obtaining unit configured to obtain, from a first divided image received by the receiving unit, color information of a first color defined in a first color gamut and color information of a second color defined in the first color gamut; a conversion unit configured to perform first color conversion processing for converting the first color into a third color defined in a second color gamut different from the first color gamut and converting the second color into a fourth color defined in the second color gamut; and a first correction unit configured to, in a case where a color difference between the third color and the fourth color is smaller than a predetermined threshold, correct the conversion parameter for the first color conversion processing such that a color difference between a fifth color obtained by converting the first color into a color defined in the second color gamut and the fourth color is greater than the color difference between the third color and the fourth color, wherein the obtaining unit, the conversion unit, and the first correction unit operate in response to the receiving unit receiving the divided image.

According to another embodiment of the present invention, an information processing method comprises: receiving, from an apparatus configured to sequentially transmit respective divided images into which an image has been divided, a divided image; obtaining, from a first divided image received by the receiving unit, color information of a first color defined in a first color gamut and color information of a second color defined in the first color gamut; performing first color conversion processing for converting the first color into a third color defined in a second color gamut different from the first color gamut and converting the second color into a fourth color defined in the second color gamut; and correcting, in a case where a color difference between the third color and the fourth color is smaller than a predetermined threshold, the conversion parameter for the first color conversion processing such that a color difference between a fifth color obtained by converting the first color into a color defined in the second color gamut and the fourth color is greater than the color difference between the third color and the fourth color, wherein the obtaining process, the conversion process, and the first correction process are operated in response to the divided image is received.

According to yet another embodiment of the present invention, a non-transitory computer-readable storage medium stores a program which, when executed by a computer comprising a processor and memory, makes the computer function as: a receiving unit configured to receive, from an apparatus configured to sequentially transmit respective divided images into which an image has been divided, a divided image; an obtaining unit configured to obtain, from a first divided image received by the receiving unit, color information of a first color defined in a first color gamut and color information of a second color defined in the first color gamut; a conversion unit configured to perform first color conversion processing for converting the first color into a third color defined in a second color gamut different from the first color gamut and converting the second color into a fourth color defined in the second color gamut; and a first correction unit configured to, in a case where a color difference between the third color and the fourth color is smaller than a predetermined threshold, correct the conversion parameter for the first color conversion processing such that a color difference between a fifth color obtained by converting the first color into a color defined in the second color gamut and the fourth color is greater than the color difference between the third color and the fourth color, wherein the obtaining unit, the conversion unit, and the first correction unit operate in response to the receiving unit receiving the divided image.

Further features of the present invention will become apparent from the following description of exemplary embodiments (with reference to the attached drawings).

### BRIEF DESCRIPTION OF THE DRAWINGS

FIG. 1 is a block diagram illustrating an example of a configuration of a system including an information processing apparatus.

FIG. 2 is a flowchart for explaining an example of the overall processing according to a first embodiment.

FIG. 3 is a flowchart for explaining an example of processing for creating a degradation-corrected table according to the first embodiment.

FIG. 4 is a diagram schematically illustrating color degradation correction processing according to the first embodiment.

FIG. 5 is a diagram for explaining blocking for each hue according to a second embodiment.

FIG. 6 is a diagram for explaining processing for correcting color degradation in a lightness direction according to the second embodiment.

FIG. 7 is a diagram for explaining a lightness conversion table according to the second embodiment.

FIG. 8 is a diagram for explaining an example of a whole image according to the second embodiment.

FIG. 9 is a diagram for explaining lightness difference correction processing for a second divided image.

FIG. 10 is a diagram for explaining a lightness conversion table for the second divided image.

FIG. 11 is a diagram for explaining color degradation correction according to a third embodiment.

FIG. 12 is a diagram for explaining an example in which the same color is converted into colors that are different between divided images.

FIG. 13 is a flowchart for explaining an example of the overall processing according to a fourth embodiment.

FIG. 14 is a diagram for explaining color degradation correction according to the fourth embodiment.

FIG. 15 is a diagram for explaining a lightness conversion table according to the fourth embodiment.

FIG. 16 is a flowchart for explaining an example of the overall processing according to a fifth embodiment.

FIG. 17 is a diagram for explaining color degradation correction according to the fifth embodiment.

FIG. 18 is a diagram for explaining a lightness conversion table according to the fifth embodiment.

FIG. 19 is a diagram for explaining a configuration of an image forming apparatus.

FIG. 20 is a diagram for explaining a UI for selection by a user.

FIG. 21 is a flowchart for explaining an example of the overall processing according to a sixth embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

When “perceptual” mapping described in Japanese Patent Laid-Open No. 2020-27948 is performed, even if a color in the color space of a digital original can be reproduced by a printer, chroma may be reduced. In addition, when “absolute colorimetric” mapping is performed, color degradation may occur among a plurality of colors included in a digital original that are outside the reproduction color gamut of a printer due to the mapping. Further, in Japanese Patent Laid-Open No. H07-203234, since inputted color image signals are uniquely compressed in a chroma direction, there are still concerns about the effect of reducing the extent of color degradation. Further, conventional mapping is expected to be performed on a whole image, and so, there is a problem that it cannot be applied in a case where printing is executed before the whole image has been received.

The embodiments of the present invention provide an information processing apparatus capable of mapping colors to a print color gamut so as to reduce the extent of color conversion caused by color conversion even in a case where printing of an image is executed while the image is being received.

### First Embodiment

The terms to be used in the specification will be defined in advance as follows.

### [Color Reproduction Gamut]

A color reproduction gamut according to the present embodiment refers to a range of colors that can be reproduced in an arbitrary color space. In the following, the color reproduction gamut will also be referred to as a color reproduction range, a color gamut, or a gamut. As an index for expressing the size of the color reproduction gamut, there is color gamut volume. The color gamut volume is a three-dimensional volume in an arbitrary color space.

Cases where chromaticity points constituting a color reproduction gamut are discrete are conceivable. For example, cases where a particular color reproduction gamut is represented using 729 points on CIE-L*a*b* and points therebetween are obtained using a known interpolation operation, such as tetrahedral interpolation or cubic interpolation, are conceivable. In such cases, a sum of calculated volumes (on CIE-L*a*b*) of tetrahedrons, cubes, or the like constituting the color reproduction gamut and corresponding to the interpolation calculation method can be used for a corresponding color gamut volume.

The color reproduction gamut and the color gamut according to the present embodiment will be described using an example in which the color reproduction gamut within the CIE-L*a*b* space is used but are not particularly limited thereto so long as similar processing can be performed, and a different color reproduction gamut may be used. Similarly, a numerical value of the color reproduction gamut according to the present embodiment indicates a volume for when cumulative calculation is performed in the CIE-L*a*b* space based on tetrahedral interpolation but is not particularly limited thereto.

### [Gamut Mapping]

Gamut mapping according to the present embodiment is processing for converting a color in a given color gamut into a color in a different color gamut. For example, mapping a color in an input color gamut to an output color gamut is referred to as gamut mapping, and conversion within the same color gamut is not referred to as gamut mapping. ICC profile maps, such as perceptual, saturation, and colorimetric, may be used in gamut mapping. In the following, assume that mapping processing in gamut mapping is referred to when “mapping processing” simply indicated.

In the mapping processing, conversion may be performed using a single 3D lookup table (LUT). The mapping processing may also be performed after color space conversion into a standard color space. For example, a configuration may be taken such that when an input color space is sRGB, the inputted colors are converted into colors in the CIE-L*a*b* color space and processing for mapping to an output color gamut is performed in the CIE-L*a*b* color space. The mapping processing may be 3D LUT processing and may be processing in which a conversion formula is used. Further, the mapping processing and the processing for conversion from a color space at the time of input to a color space at the time of output may be performed simultaneously. For example, a configuration may be taken such that at the time of input, the color space is sRGB, and at the time of output, conversion into RGB values or CMYK values unique to an image forming apparatus is performed.

### [Original Data]

Assume that original data according to the present embodiment is the entire input digital data to be processed and is constituted by one or more pages. A single page of original data may be held as image data or represented by a drawing command. A configuration may be taken such that when represented by a drawing command, the original data is rendered and, after being converted into image data, is processed. The image data is constituted by a plurality of pixels arranged two-dimensionally. The pixels hold information representing a color in the color space. The information representing a color may include an RGB value, a CMYK value, a K value, a CIE-L*a*b* value, an HSV value, an HLS value, or the like.

### [Color Difference Reduction, Color Degradation]

In the present embodiment, a post-mapping distance between colors in a predetermined color space becoming smaller than a pre-mapping distance between colors when gamut mapping is performed for any two colors will simply be referred to as “color difference reduction”. When color difference reduction occurs, it is conceivable that what had been recognized to be different colors before mapping will be recognized to be the same color after mapping due to the post-mapping color difference being reduced. Assume that in the following, cases where color difference reduction occurs and the post-conversion color difference becomes less than a predetermined threshold will be referred to as “color degradation”. The threshold to be used here will be described later.

Color degradation will be described below using a specific example. Here, it is assumed that there are a color A and a color B in a digital original, and by being mapped to a color gamut of a printer, the color A has been converted to a color C and the color B has been converted to a color D. Here, a case where a distance between the color C and the color D is smaller than a distance between the color A and the color B and a color difference between the color C and the color D is less than a predetermined threshold is a state defined as color degradation. When color degradation occurs, colors that had been recognized to be different colors in a digital original will be recognized to be the same color when printed. For example, when printing a graph in which different items are recognized by the use of different colors, if the different colors end up being recognized to be the same color due to color degradation, there is a possibility that items may be misrecognized to be the same item despite being different.

In the present embodiment, an arbitrary color space may be used as a predetermined color space for calculating a distance between colors. For example, the sRGB color space, an Adobe RGB color space, the CIE-L*a*b* color space, a CIE-LUV color space, an XYZ color system color space, an xyY color system color space, an HSV color space, an HLS color space, or the like may be used when calculating a color difference.

### [Information Processing Apparatus]

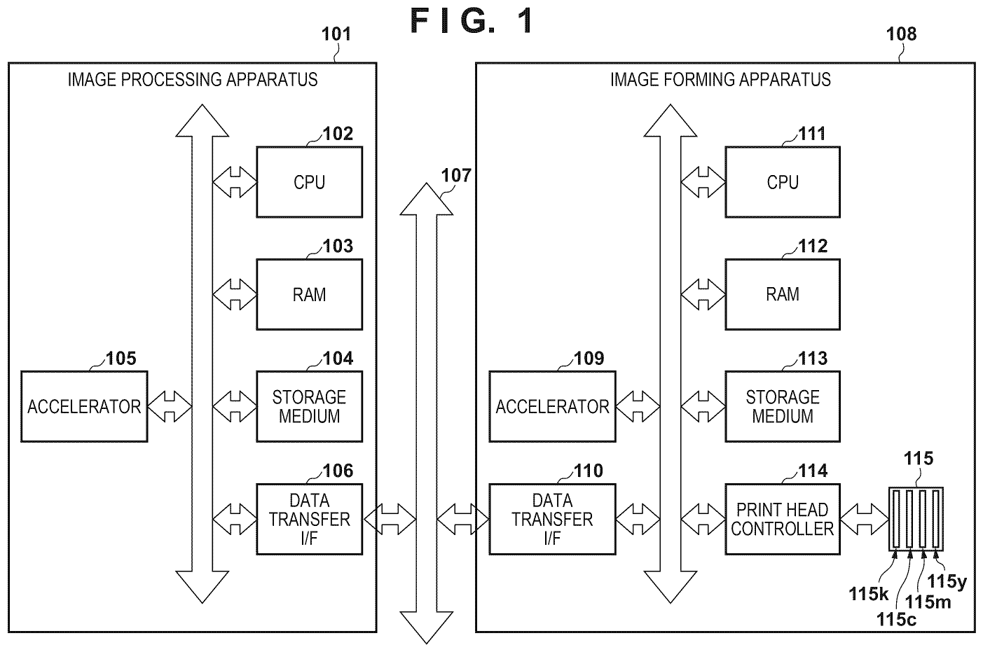

FIG. 1 is a block diagram illustrating an example of a configuration of an information processing apparatus and an image forming apparatus according to the present embodiment. In the present embodiment, a PC, a tablet, a server, or an image forming apparatus can be used as an information processing apparatus 101. The information processing apparatus 101 includes a CPU 102, a RAM 103, a storage medium 104, an accelerator 105, and a transfer I/F 106.

The CPU 102 is a central processing unit and executes various processes by reading out a program stored in the storage medium 104, such as an HDD or a ROM, to the RAM 103, which serves as a work area, and executing the program. For example, the CPU 102 obtains a command based on user input obtained via a Human Interface Device (HID) I/F (not illustrated). The CPU 102 executes various processes according to the obtained command or a program stored in the storage medium 104. The CPU 102 performs predetermined processing according to a program stored in the storage medium 104 on original data obtained through the transfer I/F 106. Then, the CPU 102 displays a result of such processing and various kinds of information on a display (not illustrated) and transmits them to an external apparatus via the transfer I/F 106.

The accelerator 105 is hardware capable of performing information processing faster than the CPU 102. The accelerator 105 is activated by the CPU 102 writing parameters and data necessary for information processing to a predetermined address of the RAM 103. The accelerator 105 reads the above parameters and data and then performs information processing on the data. The accelerator 105 according to the present embodiment is not an essential element, and equivalent processing may be performed in the CPU 102. The accelerator is specifically a GPU or a specially designed electric circuit. The above parameters may be stored in the storage medium 104 or may be obtained externally via the transfer I/F 106.

An image forming apparatus 108 is an apparatus that forms an image on a print medium. The image forming apparatus 108 according to the present embodiment includes an accelerator 109, a transfer I/F 110, a CPU 111, a RAM 112, a storage medium 113, a print head controller 114, and a print head 115.

The CPU 111 is a central processing unit and comprehensively controls the image forming apparatus 108 by reading out a program stored in the storage medium 113 to the RAM 112, which serves as a work area, and executing the program. The accelerator 109 is hardware capable of performing information processing faster than the CPU 111. The accelerator 109 is activated by the CPU 111 writing parameters and data necessary for information processing to a predetermined address of the RAM 112. The accelerator 109 reads the above parameters and data and then performs information processing on the data. The accelerator 109 according to the present embodiment is not an essential element, and equivalent processing may be performed in the CPU 111. The above parameters may be stored in the storage medium 113 or may be stored in a storage (not illustrated), such as a flash memory or an HDD.

Here, information processing to be performed by the CPU 111 or the accelerator 109 will be described. The information processing to be performed by the CPU 111 or the accelerator 109 according to the present embodiment is, for example, processing for generating, based on obtained print data, data indicating positions at which ink dots are to be formed in each scan by the print head 115.

In the present embodiment, description will be given assuming that the information processing apparatus 101 performs respective processes, which include color conversion processing and quantization processing to be described below, and based on print data generated by those processes, the image forming apparatus 108 performs image forming processing. However, if similar functions can be implemented, the processes to be performed by the information processing apparatus 101 and the image forming apparatus 108 are not particularly limited thereto, and some or all of the processes described as being performed by the information processing apparatus 101 may be executed by the image forming apparatus 108. For example, the image forming apparatus 108 may perform the color conversion processing and the quantization processing.

The information processing apparatus 101 according to the present embodiment converts a color represented in a first color gamut included in inputted image data into a color represented in a second color gamut. In the following, it is assumed that such processing for converting a color between color gamuts performed by the information processing apparatus 101 is referred to when “color conversion processing” is simply indicated. In the present embodiment, inputted image data is converted into data (ink data) indicating a color and a density of ink for each pixel to be printed by the image forming apparatus 108 by color conversion processing performed by the information processing apparatus 101.

For example, obtained print data includes image data representing an image. When the image data is data representing an image in color space coordinates (here, sRGB) that are a color representation for a monitor, the data representing an image in those color coordinates (R, G, and B) is converted into ink data (here, CMYK), which is handled by the image forming apparatus 108, by color conversion processing. A color conversion method according to the present embodiment is realized by known conversion processing, such as matrix calculation processing or processing in which a three-dimensional LUT or a four-dimensional LUT is used.

The image forming apparatus 108 according to the present embodiment uses black (K), cyan (C), magenta (M), and yellow (Y) inks as an example. Therefore, RGB signal image data is converted into image data constituting of K, C, M, and Y color signals, each with 8 bits. The color signal of each color corresponds to an application amount of each ink. Further, although the number of ink colors to be used will be described using a case where there are four colors, K, C, M, and Y, as an example, another ink colors, such as light cyan (Lc), light magenta (Lm), or gray (Gy) ink, which is low in density, may be used for the purpose of improving image quality, for example. In that case, an ink signal corresponding to that color is generated.

The information processing apparatus 101 performs quantization processing on the ink data after the color conversion processing. The quantization processing according to the present embodiment is processing for reducing the number of levels of tones of the ink data. The information processing apparatus 101 according to the present embodiment performs quantization for each pixel using a dither matrix in which thresholds with which the values of the ink data to be compared are arranged. After the quantization processing, finally, binary data indicating whether to form a dot at a respective dot formation position is generated.

After the binary data to be used for printing is generated, the print head controller 114 transfers the binary data to the print head 115. At the same time, the CPU 111 performs print control so as to operate a carriage motor, which operates the print head 115 via the print head controller 114, and to further operate a conveyance motor, which conveys a print medium. The print head 115 forms an image by scanning over the print medium and, at the same time, discharging ink droplets onto the print medium.

The information processing apparatus 101 and the image forming apparatus 108 are connected via a communication line 107. In the present embodiment, it is assumed that a local area network is used as the communication line 107; however, the information processing apparatus 101 and the image forming apparatus 108 are not particularly limited thereto so long as they can be connected so as to be capable of communication. The communication line 107 may be, for example, a USB hub, a wireless communication network in which a wireless access point is used, a connection in which a Wi-Fi Direct® communication function is used, or the like.

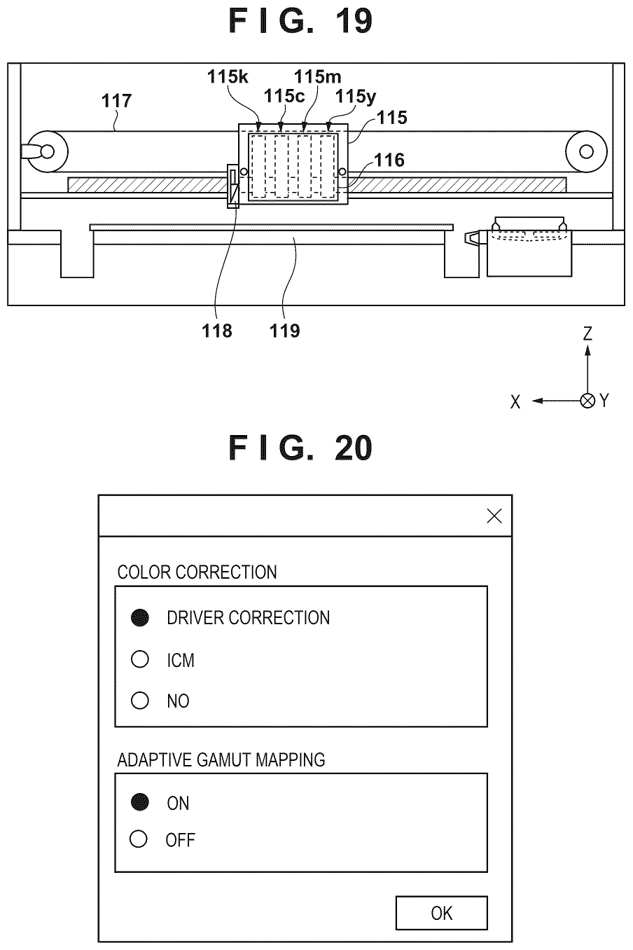

The print head 115 will be described below as having print nozzle arrays for four colors of color ink, which are cyan (C), magenta (M), yellow (Y), and black (K). FIG. 19 is a diagram for explaining the print head 115 according to the present embodiment. In the image forming processing according to the present embodiment, an image is formed by a plurality of (N) scans on a unit area proportional to one nozzle array.

The print head 115 includes a carriage 116, nozzle arrays 115k, 115c, 115m, and 115y, and an optical sensor 118. The carriage 116 on which the four nozzle arrays 115k, 115c, 115m, and 115y and the optical sensor 118 are mounted can be reciprocated along an X direction (main scanning direction) in the figure by the driving force of the carriage motor transmitted through a belt 117. As the carriage 116 moves in the X direction relative to a print medium, an ink droplet is discharged from each nozzle in the nozzle arrays in a gravitational direction (−Z direction in the figure) based on print data. With this, an image proportional to 1/N-th of a main scan is formed on the print medium mounted on a platen 119. When one main scan is completed, the print medium is conveyed along a conveyance direction (−Y direction in the figure), which intersects the main scanning direction, by a distance corresponding to a width of 1/N-th of a main scan. With these operations, an image that is a width of one nozzle array is formed by a plurality of (N) scans. By alternately repeating such a main scan and a conveyance operation, an image is gradually formed on the print medium. By doing so, it is possible to perform control so as to complete image formation for a predetermined area.

A case where printing is started while original data is being received, before the entirety of the original data has been received is considered. In that case, while one page of original data is being received, color conversion processing, quantization processing, and image forming processing are performed as described above for a partial image that has been received. By performing such processing, it is possible to reduce time required from the start of input of original data until the end of printing compared to a case where processing is performed after one page of original data has been received.

The information processing apparatus 101 according to the present embodiment receives respective divided images into which an image has been divided from an apparatus that sequentially transmits the divided images, and then, in response to receiving a divided image, obtains, from the received divided image, color information of a first color defined in a first color gamut and color information of a second color defined in the first color gamut and performs first color conversion processing for converting the first color into a third color defined in a second color gamut different from the first color gamut and converting the second color into a fourth color defined in the second color gamut. Here, in a case where a color difference between the third color and the fourth color is smaller than a threshold, the information processing apparatus 101 performs color degradation correction processing for correcting a conversion parameter for the first color conversion processing such that a color difference between a fifth color obtained by converting the first color into a color defined in the second color gamut and the fourth color is greater than the color difference between the third color and the fourth color. Color degradation correction will be described later in detail.

Here, it is assumed that the information processing apparatus 101 is an apparatus incorporated in the image forming apparatus 108 and receives divided images from an apparatus external to the image forming apparatus 108. However, it is not particularly limited to such a configuration so long as it can sequentially receive divided images and perform respective subsequent processes. For example, a configuration may be taken such that the information processing apparatus 101 is a personal computer connected with the image forming apparatus 108 or a server to which the image forming apparatus 108 is connected and receives divided images from an external apparatus or a server.

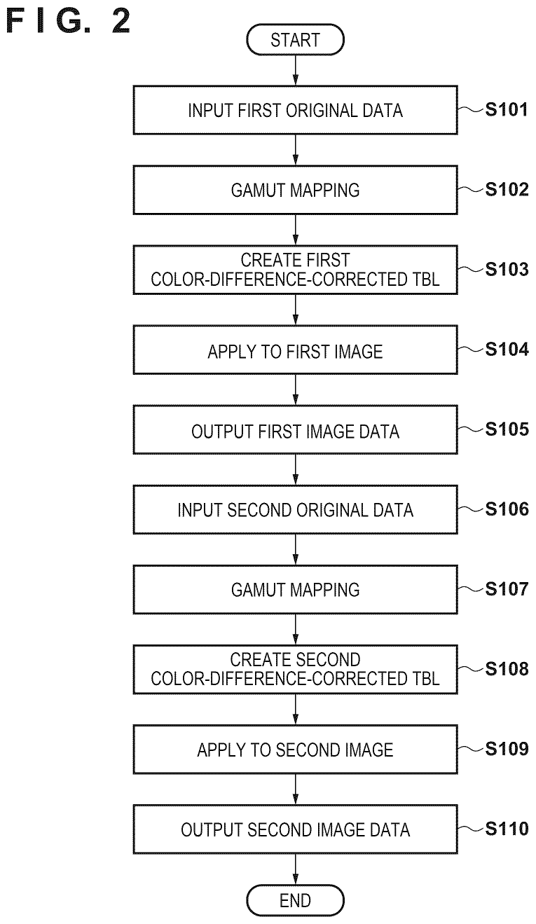

FIG. 2 is a flowchart for explaining an example of the overall processing to be performed by the information processing apparatus 101 according to the present embodiment. The information processing apparatus 101 according to the present embodiment can reduce the extent of color degradation by increasing a distance between colors in a color space after color conversion for a combination of colors in which color degradation occurs due to color conversion processing. The processing of FIG. 2 is realized, for example, by the CPU 102 reading out to the RAM 103 a program stored in the storage medium 104 and executing the program. The processing of FIG. 2 may be performed by the accelerator 105. It is assumed that the processing of FIG. 2 is executed in response to input of image data.

The information processing apparatus 101 according to the present embodiment sequentially receives divided images into which an image has been divided and, upon receiving a divided image, generates a conversion parameter for that received divided image. In FIG. 2, assuming that two images, which are a first divided image and a second divided image, are received as divided images, processing with the first divided image as the processing target is performed in steps S101 to S105, and processing with the second divided image as the processing target is performed in steps S106 to S110. The respective processes will be described below assuming that the first divided image is a divided image that is received earlier than the second divided image.

In step S101, the CPU 102 obtains first original data as the first divided image into which an image to be used for printing has been divided. In the present embodiment, it is assumed that an image stored in the storage medium 104 is obtained; however, an image may be inputted from an external apparatus through the transfer I/F 106. The CPU 102 according to the present embodiment obtains values representing colors represented in a predetermined color space included in the original data. For example, sRGB data, Adobe RGB data, CIE-L*a*b* data, CIE-LUV data, XYZ color system data, xyY color system data, HSV data, or HLS data are used as the values representing colors.

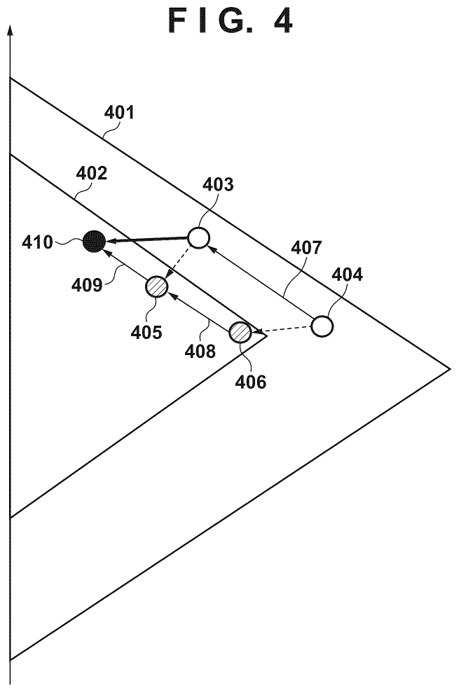

Regarding the original data used here, an image that includes a pixel including color information of a first color and a pixel including color information of a second color is obtained, and color information of such an image is obtained. In the following, such a first color and a second color are used in each process as unique colors (here, a color 403 and a color 404), which will be described later with reference to FIG. 4 and the like, but the colors to be used in the processes are not limited to these two, and three or more colors may be used.

In step S102, the CPU 102 performs color conversion processing on the first original data using a conversion parameter stored in advance in the storage medium 104. The conversion parameter according to the present embodiment is a gamut mapping table, and gamut mapping in which the gamut mapping table is used is performed for the color information of each pixel of the first original data as color conversion processing. The gamut-mapped first original data is stored in the RAM 103 or the storage medium 104.

The CPU 102 according to the present embodiment uses a three-dimensional look-up table as the gamut mapping table. The CPU 102 references the gamut mapping table and can thereby calculate a combination of output pixel values (Rout, Gout, Bout) obtained by performing gamut mapping on a combination of input pixel values (Rin, Gin, Bin). When Rin, Gin, and Bin, which are input values, each have 256 tones, Table 1 [3], which is a table that has a total of 16,777,216 (=256×256×256) combinations of output values can be used as the gamut mapping table. The color conversion processing may be realized by, for example, performing the processes indicated in the following Equations (1) to (3) for each pixel of an image constituted by RGB pixel values of the image data inputted in step S101.

$$Rout = Table 1 [ Rin ] [ Gin ] [ Bin ] [ 0 ] \qquad ( 1 )$$

$$Gout = Table 1 [ Rin ] [ Gin ] [ Bin ] [ 1 ] \qquad ( 2 )$$

$$Bout = Table 1 [ Rin ] [ Gin ] [ Bin ] [ 2 ] \qquad ( 3 )$$

The number of grids of the gamut mapping table is not limited to 256 grids. For example, the number of grids may be reduced from 256 grids (e.g., to 16 grids) so as to determine output values by performing interpolation from table values of a plurality of grids. Known processing to be performed when using a LUT table, such as reducing the table size as described above, may be additionally executed as appropriate.

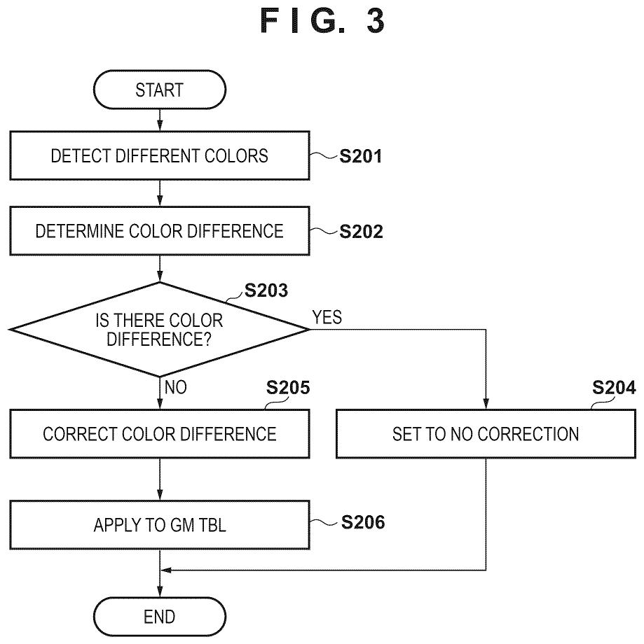

In step S103, the CPU 102 creates a color-degradation-corrected table based on the first original data inputted in step S101, image data after gamut mapping performed in step S102, and the gamut mapping table. The format of the color-degradation-corrected table is similar to the format of the gamut mapping table. The processing performed in step S104 and the color-degradation-corrected table will be described later with reference to FIGS. 3 and 4.

In step S104, the CPU 102 generates color-degradation-corrected image data in which color degradation has been corrected, using the color-degradation-corrected table created in step S103, with image data inputted in step S101 as input. The generated color-degradation-corrected image data is stored in the RAM 103 or the storage medium 104. In step S105, the CPU 102 outputs the color-degradation-corrected image data stored in step S104 from the information processing apparatus 101 through the transfer I/F 106.

In step S106, the CPU 102 obtains second original data as the second divided image into which the image to be used for printing has been divided. Steps S106 to S110 are performed similarly to step S101 to S105 except for the divided image to be processed being changed from the first original data to the second original data, and so detailed description here will be omitted. When step S110 is completed, the processing of FIG. 1 is terminated.

In FIG. 2, a case where two divided images, which are the first original data and the second original data, are used has been described; however, the number of divided images is not limited thereto, and a configuration may be taken so as to divide the image into three or more divided images and perform processing on each thereof. In that case, processing similar to steps S101 to S105 is performed on each divided image.

The color conversion processing in gamut mapping performed in steps S102 and S107 may be mapping from a color in the sRGB color space to a color in the color reproduction gamut for printing by the image forming apparatus 108. With such processing, it is possible to reduce a decrease in chroma and color difference caused by performing gamut mapping to what is within the color reproduction gamut of the image forming apparatus 108. In addition, in gamut mapping, parameter selection in which tone reproduction is prioritized may be performed.

The color-degradation-corrected table created in step S103 will be described below with reference to FIG. 3. FIG. 3 is a flowchart for explaining an example of processing for creating the color-degradation-corrected table in step S103. The processing of FIG. 3 is realized, for example, by the CPU 102 reading out to the RAM 103 a program stored in the storage medium 104 and executing the program. The processing of FIG. 3 may be performed by the accelerator 105. In the following, the first divided image (original data) and the second divided image may be referred to as image data, an image, or original data without distinguishing therebetween. Further, although step S103 will be described here, similar processing is performed in step S108.

In step S201, the CPU 102 detects all the unique colors included in the image data inputted in step S101. Here, it is assumed that a unique color refers to a color detected in the image data, and each with a different pixel value is detected as a different unique color. Here, results of detection of a unique color are stored in the RAM 103 or the storage medium 104 as a unique color list. Although it is assumed that a unique color is designated using components, such as RGB, one unique color may have a range for each RGB component, and the contents of a unique color may vary depending on the color detection method. The unique color list is initialized at the start of step S201. The CPU 102 repeats the processing for detecting a unique color for each pixel of the image data and determines, for all the pixels included in the image data, whether the color of each pixel is a color that is different from the unique colors that have been detected thus far. The colors that have been determined to be unique colors by such processing are stored as unique colors in the unique color list.

When the input image data is sRGB data, each component has 256 tones; therefore, there are unique colors from a total of 16, 777, 216 (=256×256×256) colors. When all of these colors are detected as unique colors and stored in the unique color list, the number of colors becomes enormous and processing speed decreases. From such a viewpoint, the CPU 102 may discretely detect unique colors. For example, the CPU 102 may reduce colors from 256 tones to 16 tones and then detect a unique color. In such a case, the CPU 102 may group each set of 16 neighboring colors and thereby set 256 tones of colors into 16 tones. With such color reduction processing, it is possible to detect unique colors from a total of 4096 (=16×16×16) colors, thereby increasing the processing speed.

In step S202, the CPU 102 detects a combination of colors in which color degradation occurs among the combinations of unique colors included in the image data based on the unique color list detected in step S201. The processing performed in step S202 will be described with reference to a schematic diagram of FIG. 4. In FIG. 4, a color gamut of the input image data before being subjected to color conversion processing is indicated as a color gamut 401, and a color gamut after being converted by gamut mapping is indicated as a color gamut 402 on a plane that uses two axes, an L* axis and a C* axis, in the CIE-L*a*b* color space. The input image data includes the color 403 (first color) and the color 404 (second color), which are illustrated in the color gamut 401. A color 405 and a color 406 are colors in the color gamut 402. The color 405 is a color for when gamut mapping has been performed on the color 403, and the color 406 is a color for when gamut mapping has been performed on the color 404.

The CPU 102 according to the present embodiment determines that color degradation occurs when a color difference 408 between the color 405 and the color 406 is smaller than a predetermined threshold. Here, it is assumed that is determined color degradation has occurred when the color difference 408 is smaller than a color difference 407 between the color 403 and the color 404 in addition to the color difference 408 between the color 405 and the color 406 being smaller than the predetermined threshold. The threshold used here can be arbitrarily set according to a user-desired condition. The threshold may be a fixed value or may be a value that varies depending on the combination of colors. For example, the CPU 102 may use the pre-conversion color difference between the combination of colors (here, the color difference 407 between the color 403 and the color 404) as the above predetermined threshold. The CPU 102 repeats such determination processing for all the combinations of colors in the unique color list.

In the present embodiment, a color difference between two colors is calculated as a Euclidean distance ΔE in a color space. Since the CIE-L*a*b* color space is a visually uniform color space, the Euclidean distance can be approximated to an amount of change in color. Therefore, humans tend to perceive that colors are close when the Euclidean distance in the CIE-L*a*b* color space decreases and perceive that colors are apart when the Euclidean distance increases. A case where the Euclidean distance (hereinafter, referred to as a color difference ΔE) in the CIE-L*a*b* color space is used as a color difference will be described below. The color information in the CIE-L*a*b* color space is represented using a color space with three axes, L*, a*, and b*. The color 403 is represented using L403, a403, and b403. The color 404 is represented using L404, a404, and b404. The color 405 is represented using L405, a405, and b405. The color 406 is represented using L406, a406, and b406. When the input image data is represented by another color space, the input image data may be converted to the CIE-L*a*b* color space by a known color space conversion technique, and subsequent processing may be performed as is in that color space. The equations for calculating the color difference ΔE 407 and the color difference ΔE 408 are as follows.

$$Δ {E}_{407} = \sqrt{{( {L}_{403} - {L}_{404} )}^{2} + {( {a}_{403} - {a}_{404} )}^{2} + {( {b}_{403} - {b}_{404} )}^{2}} \qquad ( 4 )$$

$$Δ {E}_{408} = \sqrt{{( {L}_{405} - {L}_{406} )}^{2} + {( {a}_{405} - {a}_{406} )}^{2} + {( {b}_{405} - {b}_{406} )}^{2}} \qquad ( 5 )$$

The CPU 102 determines that color degradation occurs when the color difference ΔE 408 is smaller than the threshold. If the post-conversion color difference ΔE 408 is to an extent to which colors can be distinguished to be different based on human color difference identification, it is possible to determine that color degradation has not occurred and the color difference does not need to be corrected. From such a viewpoint, the threshold used here may be, for example, 2.0. As described above, the threshold may be the same value as ΔE 407. The CPU 102 may determine that color degradation occurs when the color difference ΔE 408 is smaller than 2.0 and when the color difference ΔE 408 is smaller than the color difference ΔE 407.

In step S203, the CPU 102 determines whether the number of combinations of colors for which it has been determined in step S202 that color degradation occurs is zero. If it is zero, the processing proceeds to step S204, and otherwise, the processing proceeds to step S205; in step S204, the CPU 102 determines that the input image data is an image that does not need color degradation correction and ends the processing of FIG. 2.

Although description has been given assuming that an image is determined to not need color degradation correction when the number of colors for which it is determined that color degradation occurs is zero, processing is not particularly limited thereto. For example, the CPU 102 may determine whether an image does not need color degradation correction based on the number of combinations of colors in which color degradation occurs relative to the total number of combinations of unique colors. In that case, the CPU 102 may determine that an image needs color degradation correction if the number of combinations of colors in which color degradation occurs is a majority of the total number of combinations of unique colors, for example. With such processing, it is possible to perform setting so as to execute color degradation correction only when it can be determined that color degradation correction is more necessary.

In step S205, the CPU 102 performs color degradation correction for a combination of colors in which color degradation occurs, based on the input image data and the degradation-corrected table.

The color degradation correction performed by the CPU 102 according to the present embodiment will be described in detail with reference to FIG. 4. In FIG. 4, it is determined that color degradation occurs in the color combination of the color 403 and the color 404. Therefore, the CPU 102 according to the present embodiment corrects the conversion parameter to be used in the color conversion processing such that a post-color-conversion color difference between the color 403 and the color 404 will be larger. That is, the CPU 102 can correct the conversion parameter so as to increase a post-color-conversion distance between colors in a given color space. With such correction, the extent of color degradation can be reduced. Here, the CPU 102 sets a distance between colors (distance between distinguishable colors) that allows them to be identified as different colors based on characteristics of visual perception of humans and corrects the conversion parameter of the color conversion processing so that a post-conversion color difference between the two colors will assume such a distance between colors.

Here, the CPU 102 sets the above distance between distinguishable colors as the distance between colors whose color difference ΔE is 2.0 or more. The conversion parameter may be corrected such that the post-conversion color difference between two colors is equivalent to the color difference ΔE 407 between the pre-conversion color 403 and color 404.

The processing for correcting color degradation is repeated for all the combinations of colors in which color degradation occurs. The results of color degradation correction proportional to the number of combinations of colors are stored in a table in association with the uncorrected color information and the corrected color information in step S206, which will be described later, and a table in which a corresponding parameter has been thus corrected is set as a color-degradation-corrected table. In the example illustrated in FIG. 4, the color information is represented by color information in the CIE-L*a*b* color space. Therefore, the CPU 102 may convert the color information to be stored in the color-degradation-corrected table to a color in the color space of the input image data and a color in the color space of the output image data and then store the color information. In that case, it is assumed that uncorrected color information is converted into color information in the color space of the input image data, and corrected color information is converted into color information in the color space of the output image data and then stored in the color-degradation-corrected table.

Next, such color degradation correction processing will be described in detail. The CPU 102 obtains a color difference correction amount 409 necessary for the post-conversion color difference ΔE 408 to be the distance between distinguishable colors. In the present embodiment, the distance between distinguishable colors is set to be the color difference ΔE 2.0, and a difference between such a value 2.0 and the color difference ΔE 408 is calculated as the color difference correction amount 409. The CPU 102 may calculate the color difference correction amount 409 as a difference between the color difference ΔE 407 and the color difference ΔE 408.

In FIG. 4, a color obtained by correcting the color 405 by the color difference correction amount 409 on a line extending from the color 406 to the color 405 in the CIE-L*a*b* color space is indicated as a color 410. In the present embodiment, description will be given assuming that the color 410 thus calculated by color conversion processing after color degradation correction is a color that is present on a line extending from the color 406 to the color 405. However, the present invention is not particularly limited thereto so long as the color difference between the color 406 and the color 410 is greater than or equal to a sum of the color difference ΔE 408 and the color difference correction amount 409. For example, the color 410 may be a color at a position apart from the color 406 in the CIE-L*a*b* color space by a distance that is proportional to a sum of the color difference ΔE 408 and the color difference correction amount 409 in any of a lightness direction, a chroma direction, and a hue angle direction. The color 410 may be a color that is apart from the color 406 by a sum of the color difference ΔE 408 and the color difference correction amount 409, taking into account not only one direction but also each of the lightness direction, the chroma direction, and the hue angle direction.

In the example of FIG. 4, the color conversion parameter is corrected such that a post-conversion color of the color 403 will be the color 410 instead of the color 405. However, so long as a post-conversion color difference between two colors is the distance between distinguishable colors as described above, a post-conversion color of the color 404 may be a different color from the color 406, or the post-conversion colors of both the color 403 and the color 404 may be different colors from uncorrected colors, for example. In the example of FIG. 4, when an attempt is made to correct the color 406 by the color difference correction amount 409 on a line extending from the color 405 to the color 406 in the CIE-L*a*b* color space, it goes out of the color gamut 402; therefore, such correction cannot be performed. Therefore, when changing the post-conversion color of the color 404 by correcting the conversion parameter, setting is made such that the color will be on a boundary plane of the color gamut 402 and an inter-color distance thereof from the color 405 is the distance between distinguishable colors. Here, if a distance between two post-conversion colors does not reach the distance between distinguishable colors simply by changing the post-conversion color of the color 404, the deficiency to the distance between distinguishable colors may be compensated for by correcting the conversion parameter so as to change the post-conversion color of the color 403.

In step S206, the CPU 102 corrects the gamut mapping table by using a result of color degradation correction of step S205 and sets it as the color-degradation-corrected table. Here, the gamut mapping table that has not been correct is a table that converts the color 403, which is an input color, to the color 405, which is an output color, and the color-degradation-corrected table is a table that converts the color 403, which is an input color, to the color 410, which is an output color. As a result of step S205, the table changes into that which converts the color 403, which is an input color, to the color 410, which is an output color. The correction of the gamut mapping table is performed repeatedly for all the combinations of colors in which color degradation occurs. With such processing, the color-degradation-corrected table is created.

With the processing illustrated in FIG. 3, by creating the color-degradation-corrected table and then converting the input image using such a table, it is possible to increase the distance between colors for a combination of colors in which color degradation occurs after conversion among the combinations of unique colors included in the input image. Therefore, it is possible to reduce the extent of color degradation in the combination of colors in which color degradation occurs due to conversion.

If the input image data is sRGB data, the gamut mapping table is created assuming that the input image data has 16, 777, 216 colors. The gamut mapping table created under this assumption is created taking into account color degradation and chroma for all the colors including those not included in the actual input image data. With the processing described in the present embodiment, by correcting the conversion parameter only for the colors in which color degradation occurs after conversion that have been detected in the input image data, it is possible to create an adaptive degradation-corrected table for the input image data. Therefore, color conversion processing in which the extent of color degradation is reduced can be executed by gamut mapping suitable for the input image data.

The processes described with reference to FIGS. 3 and 4 can be executed on either of the first original data and the second original data. In the present embodiment, description will be given assuming that the same processing is separately performed on each of the first original data and the second original data.

In the present embodiment, the processing in a case where the input image data is one page of an image has been described, but the number of pages of the input image data is not particularly limited. When the input image data is a plurality of pages, the flow indicated in FIG. 2 may be performed spanning all the pages or may be performed for each page. With such processing, even when the input image data is a plurality of pages, in a case where color degradation occurs when executing printing of an image while receiving that image, it is possible to similarly reduce the extent of that color degradation.

Further, in the present embodiment, the degradation-corrected table is created by correcting the gamut mapping table; however, the present invention is not particularly limited to such processing so long as the post-conversion color difference takes on a similar value. For example, similar conversion may be performed by further performing color conversion according to a different gamut mapping table on image data that has been subject to gamut mapping in which a gamut mapping table that has not been corrected for color degradation has been used as is. In such a case, in step S205, a table for converting color information converted according to uncorrected gamut mapping data into color-degradation-corrected color information is created as a post-gamut-mapping correction table. The post-gamut-mapping correction table generated here is a table for converting the color 405 of FIG. 4, as input, into the color 410. In this case, in step S105, color conversion processing is performed by applying the post-gamut-mapping correction table on the gamut-mapped image data.

In the present embodiment, the processes indicated in FIGS. 2 and 3 are assumed to be started (automatically) in response to accepting input of image data but may be configured so as to be executed based on a user instruction. For example, the CPU 102 may accept user input as to whether to execute each information process according to the present embodiment in a UI screen as illustrated in FIG. 20 to be described below. In the UI screen of FIG. 20, a toggle button for selecting the type of color correction is displayed. Further, in the UI screen of FIG. 20, a toggle button for selecting whether to perform gamut mapping using an adaptive degradation-corrected table by ON and OFF is displayed. With such a configuration, it is possible to switch whether to perform adaptive gamut mapping according to a user instruction. As a result, it is possible to perform adaptive gamut mapping when the user wishes to reduce the extent of color degradation.

In the present embodiment, description has been given assuming that a color-degradation-corrected table is separately created for each of the first original data and the second original data. However, when creating a color-degradation-corrected table for the second original data, information on the first original data may be additionally used. For example, in step S202, the CPU 102 may detect a combination of colors in which color degradation occurs, using a unique color detected in step S201 for the first original data in addition to a unique color detected in step S201 for the second original data. By doing so, it is possible to correct color degradation for the second original data, taking into account colors used in the first original data, and reduce the extent of color degradation so as to avoid unnaturalness in an image to be ultimately formed by combining all the original data.

### Second Embodiment

[Correction of Repulsive Force within Same Hue]

The information processing apparatus 101 according to the first embodiment detects the number of combinations of colors in which color degradation occurs for all the combinations of unique colors included in the image data and performs color degradation correction processing for each of those. Meanwhile, cases in which it is possible to consider that color degradation has not occurred without even determining whether color degradation has occurred, such as with a combination of colors whose hues are significantly different, are conceivable. Accordingly, the information processing apparatus 101 according to the second embodiment groups a portion corresponding to a hue range among the detected plurality of unique colors as one color group and performs color degradation correction processing within the group. In the following, it is assumed that unique colors thus grouped as one color group is referred to when “group” is simply indicated. Further, in the present embodiment, the first divided image (original data) and the second divided image may be referred to as image data, an image, or original data without distinguishing therebetween.

The information processing apparatus 101 according to the present embodiment can group detected unique colors by each predetermined hue angle, for example, and perform color degradation correction processing similar to that of the first embodiment within the group. By thus grouping not all the detected unique colors but a portion thereof as a single color group and performing color degradation correction processing only within that portion, the number of combinations to be calculated is reduced, and thereby, the processing load and processing time can be reduced.

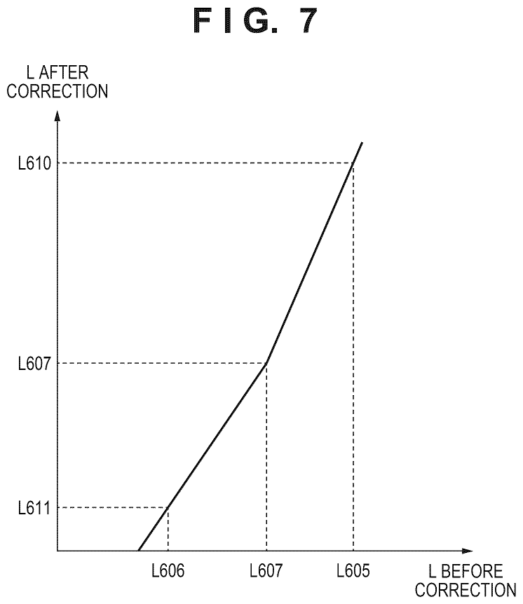

In the present embodiment, when performing color degradation correction, color degradation correction may be performed so that a change in a post-conversion color caused by the color degradation correction occurs only in the lightness direction. By a change in a post-color-conversion color due to the correction of the conversion parameter occurring only in the lightness direction, it is possible to reduce the change in the color appearance caused by the correction of the conversion parameter. In the present embodiment, the conversion parameter may be corrected so that a lightness after conversion according to the color conversion processing after conversion parameter correction is determined based on a lightness of an inputted color and the chroma does not change from that before correction, as in FIG. 7 to be described later, for example.

If a pre-gamut-mapping color difference ΔE is greater than a minimum color difference that can be identified, a color difference ΔE to be retained need only be greater than a minimum color difference ΔE that can be identified. In such a case, it is conceivable to set the conversion parameter such that the post-conversion color difference between two colors approaches the pre-conversion color difference in the color conversion according to gamut mapping. From such a viewpoint, the information processing apparatus 101 according to the present embodiment may correct the conversion parameter so that the post-conversion color is determined based on the post-conversion color and the pre-conversion color difference between colors of the combination. By the post-gamut-mapping color difference between two colors being set to the pre-gamut-mapping color difference by color degradation correction, it is possible to reproduce the pre-gamut-mapping distinguishability even after color conversion. Such a color-degradation-corrected post-gamut-mapping color difference may be greater than a pre-gamut-mapping color difference. In this case, it can be made easier to distinguish between two colors after color conversion than before gamut mapping. Such processing for correcting the conversion parameter will be described below.

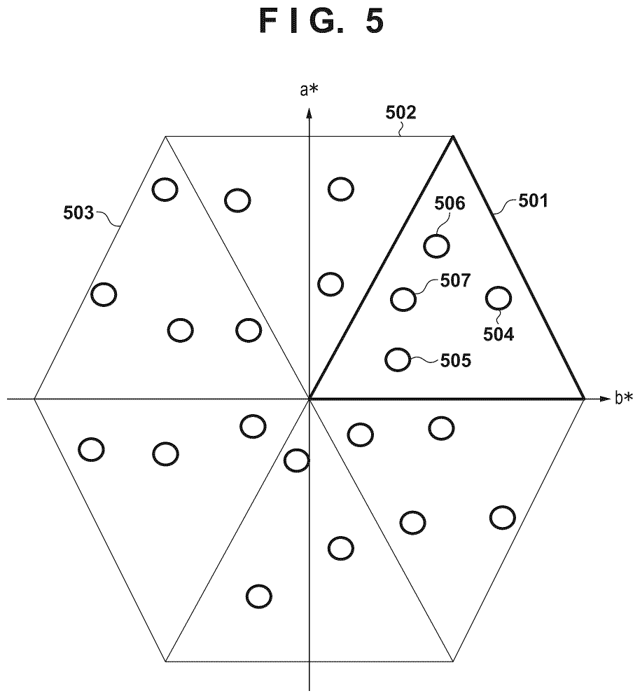

An example of processing for determining whether color degradation occurs, performed in step S202 by the information processing apparatus 101 according to the present embodiment, will be described below with reference to FIG. 5. FIG. 5 is a diagram in which two axes, an a* axis and a b* axis, of the CIE-L*a*b* color space are represented in a plane and a plurality of unique colors are plotted. In the present embodiment, as described above, the unique colors within a predetermined hue angle are grouped as one color group. A hue range 501 represents a range in which a plurality of unique colors within a predetermined hue angle are regarded as one color group. In FIG. 5, 360 degrees of hue angle are equally divided into six parts, and the hue range 501 represents a range of 0 degree to 60 degrees. The hue range used for grouping is preferably a hue range that can be recognized as the same color and can be arbitrarily set by the user. For example, in the CIE-L*a*b* color space, a hue range to be grouped as one color group may be set to be a range of 30 degrees to 60 degrees. If the angle is 60 degrees, it can be considered that division and grouping are performed into six color groups of red, green, blue, cyan, magenta, and yellow. If the angle is 30 degrees, the division can be performed according to a color between the colors grouped by 60 degrees.

As illustrated in FIG. 5, a hue range that has been grouped by a fixed angle may be set, or a hue range may be set according to the unique colors included in the image data. For example, a configuration may be taken so as to determine ranges of hue angles, each a range that is set to appear visually uniform (to be the same color), and unique colors are grouped in each of the ranges of hue angles thus set.

Further, in the present embodiment, description will be given assuming that color degradation correction processing is performed using unique colors in one group, which has been grouped using a hue angle; however, the processing for calculating the number of combinations in which color degradation occurs, which will be described below, may be performed using unique colors included in two groups with adjacent hue angle ranges. By thus detecting combinations spanning adjacent hue ranges, it is possible to prevent a steep change in the number of combinations of colors in which color degradation occurs when an area in which to detect the combinations is shifted by one. In this case, if a range that is likely to be recognized as the same color (in the CIE-L*a*b* color space) is 30 degrees, by setting a hue angle range to be formed into one group to 15 degrees, a hue angle for when two hue ranges are combined is 30 degrees. Therefore, it is possible to detect a combination from among hue angle ranges that are likely to be recognized as the same color.

The CPU 102 calculates the number of combinations of colors in which color degradation occurs for the combinations of unique colors within the hue range 501. In FIG. 5, a color 504, a color 505, a color 506, and a color 507 are indicated as colors included in the hue range 501. The CPU 102 according to the present embodiment determines whether color degradation occurs due to color conversion processing for all combinations of the four colors, the color 504, the color 505, the color 506, and the color 507. Such determination processing is repeated in all the hue ranges. With such processing, it is possible to detect a combination of colors in which color degradation occurs for each hue range and calculate the number of such combinations. In FIG. 5, there are a total of six color combinations within the hue range 501. The detection of a combination of colors in which color degradation occurs can be performed similarly to the first embodiment. In the following, it is assumed that, when a combination of colors (two colors) is described, unless specifically mentioned, a combination within one hue range is described.

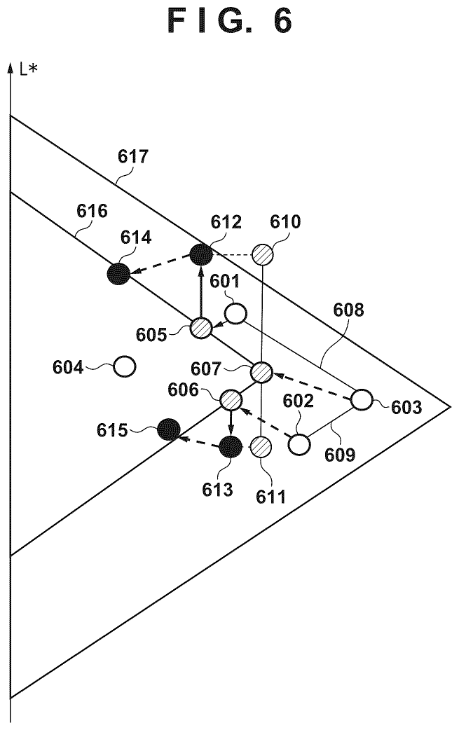

The CPU 102 according to the present embodiment selects a color (reference color) that serves as a reference from among the unique colors included in the grouped color group and, based on a color difference between the reference color and another color, corrects the conversion parameter for the color conversion processing so as to determine the post-conversion color of that other color. The CPU 102 according to the present embodiment can generate, based on the lightness of the reference color and the lightness of a color (hereinafter, referred to as a scale color) different from the reference color, a function (lightness conversion function) for calculating the lightness of a color to be outputted from the lightness of an inputted color in the color conversion processing after conversion parameter correction. In the present embodiment, two scale colors are set for the reference color, one color with higher lightness and one color with lower lightness, and the above lightness conversion function is generated based on the reference color and the two scale colors. The lightness conversion function will be described later as Equation (8). Here, a color 603 (and post-conversion color 607 thereof) is the reference color and a color 601 (and post-conversion color 605 thereof) is the scale color in FIG. 6 to be described later, and a post-conversion color 612 (or a color 614) of the color 601 according to post-degradation-correction gamut mapping is calculated based on the color 605, the color 607, and a color difference between the color 603 and the color 601; such processing will be described later.

An example of the color degradation correction processing performed in step S205 by the information processing apparatus 101 according to the present embodiment will be described below with reference to FIG. 6. In FIG. 6, the color gamut of the input image data before being subjected to the color conversion processing is indicated as a color gamut 617, and the color gamut after being converted by gamut mapping is indicated as a color gamut 616 on a plane that uses two axes, the L* axis and the C* axis, in the CIE-L*a*b* color space. L* represents lightness and C* represents chroma. In addition, the colors 504 to 507 included in the hue range 501 before the color conversion processing is performed are plotted in the color gamut 617 as the colors 601 to 604, respectively. In addition, the colors 605 to 607 are colors in the color gamut 616 after the colors 601 to 603 have been converted by gamut mapping, respectively. Here, a color 604 is assumed to be the same color even after color conversion according to gamut mapping.

The CPU 102 according to the present embodiment can calculate a correction ratio (rate), which is a reflection rate of correction of the conversion parameter in color degradation correction, based on a ratio of the number of combinations of colors in which color degradation occurs to the number of combinations of colors included in the group. For example, the CPU 102 according to the present embodiment calculates a correction ratio R for a given group as follows.

$$R = number of combinations of colors in which color degradation occurs / number of combinations of colors included in the group$$

The above correction ratio R decreases as a proportion of the combinations of colors in which color degradation occurs within a group decreases, and increases as the proportion increases. For example, in the examples of FIGS. 5 and 6, the number of combinations of colors in the group is six, and when it is determined that color degradation occurs in four of the combinations, the correction ratio R is calculated to be 0.667. By performing correction of the conversion parameter using such a correction ratio, it is possible to increase the level of correction of color degradation as the proportion of the combinations of colors in which color degradation occurs in the group increases.

The CPU 102 according to the present embodiment can set the above reference color from among the unique colors included in the group. In the present embodiment, among the unique colors included in the group, a color (maximum chroma color) with the greatest chroma is set as the reference color. In addition, the CPU 102 sets a color (maximum lightness color) having the greatest lightness and a color (minimum lightness color) having the least lightness as the scale colors for the reference color. In the example of FIG. 6, the color 601 is the maximum lightness color, a color 602 is the minimum lightness color, and the color 603 is the maximum chroma color.

In color degradation correction, the CPU 102 according to the present embodiment generates a corresponding lightness conversion function for each of a unique color (light color group) whose lightness is greater than or equal to the lightness of the maximum chroma color and a unique color (dark color group) whose lightness is less than that of the maximum chroma color. The processing for calculating a correction amount based on the correction ratio R, the maximum lightness color, the minimum lightness color, and the maximum chroma color that is performed by the CPU 102 according to the present embodiment will be described below.

The CPU 102 calculates each of a correction amount Mh for the light color group and a correction amount Ml for the dark color group separately (the use of these correction amounts will be described later in detail). In the following, the color 601, which is the maximum lightness color, is expressed using L601, a601, and b601. Further, the color 602, which is the minimum lightness color, is expressed using L602, a602, and b602. Further, the color 603, which is the maximum chroma color, is expressed using L603, a603, and b603. Here, the CPU 102 may set a value obtained by multiplying the color difference ΔE between the maximum lightness color and the maximum chroma color by the correction ratio R, for example, as the correction amount Mh. Further, the CPU 102 may set a value obtained by multiplying the color difference ΔE between the maximum chroma color and the minimum lightness color by the correction ratio R, for example, as the correction amount Ml. The examples of equations for calculating the correction amount Mh and the correction amount Ml are indicated as Equations (6) and (7) below.

$$Mh = \sqrt{{( {L}_{601} - {L}_{603} )}^{2} + {( {a}_{601} - {a}_{603} )}^{2} + {( {b}_{601} - {b}_{603} )}^{2}} \times R \qquad ( 6 )$$

$$Ml = \sqrt{{( {L}_{602} - {L}_{603} )}^{2} + {( {a}_{602} - {a}_{603} )}^{2} + {( {b}_{602} - {b}_{603} )}^{2}} \times R \qquad ( 7 )$$

In FIG. 6, a color difference between the color 601 and the color 603 is indicated by a color difference ΔE 608, and a color difference between the color 602 and the color 603 is indicated by a color difference ΔE 609. Therefore, the correction amount Mh and the correction amount Ml are values obtained by multiplying each of such color difference ΔE 608 and color difference ΔE 609 by R.

The CPU 102 according to the present embodiment generates a lightness conversion table for each hue range. The lightness conversion table according to the present embodiment is a table that indicates the lightness (post-conversion lightness) of an output pixel according to post-color-degradation-correction gamut mapping for the lightness of an input pixel. A method of creating such a lightness correction table will be described below.

The lightness conversion table according to the present embodiment is a 1D LUT. Such a 1DLUT is smaller in volume compared to a 3D LUT with same the number of items, and it is expected that the processing time required for transfer will be reduced. A post-conversion lightness to be stored in the lightness conversion table is calculated based on the lightness of the reference color, the lightness of the input color, and the lightness of the maximum lightness color (or the minimum lightness color), and the lightness and the correction amount of a color obtained by converting the reference color by gamut mapping (separately for the light color group and the dark color group in the present embodiment). In the following, description will be given assuming that a color to be inputted is a color of the light color group; however, when a color of the dark color group is used, it is possible to perform similar processing using the minimum lightness color instead of the maximum lightness color.

FIG. 7 is a graph illustrating an example of components of the lightness conversion table according to the present embodiment. In FIG. 7, the lightnesses of input colors in the lightness conversion table are indicated on the horizontal axis, and the lightnesses to be outputted are indicated on the vertical axis. L605 to L611 of FIG. 7 correspond to lightnesses of reference numerals 605 to 611 of FIG. 6. That is, in FIG. 7, the lightnesses, after conversion by gamut mapping, of the maximum lightness color, the reference color, and the minimum lightness color are illustrated as L605, L607, and L606, respectively. In the following, only the lightnesses L607 to L605 of the lightness group range will be described in the graph of FIG. 7.

L610 is a value to be outputted when L605 is inputted to the lightness conversion table and is a value obtained by adding the correction amount Mh to L607. In FIG. 6, a color for which the color 607 has been moved in the lightness direction by the correction amount Mh is indicated as the color 610.

First, the color 610 and a color 612 and the color 614, which are set based on the color 610, will be described. Such a color 610 is a color that has a color difference between the color 603 and the color 601 in a lightness direction as a color difference from the color 607. A color for which the post-conversion color 605 of the color 601 has been moved in the lightness direction so as to have such a lightness L610 is a color 612. By performing color degradation correction so that the post-conversion color of the color 601 is the color 612, the change of the post-color-conversion color is performed only in the lightness direction, and it is possible to reduce the change in color appearance due to correction of the conversion parameter. In addition, in terms of characteristics of visual perception, sensitivity to a lightness difference is high; therefore, by converting a color difference that includes chroma into a lightness difference, it is possible to provide a color that is likely to be perceived as having a larger color difference after conversion even if the lightness difference is small in terms of characteristics of visual perception. In addition, due to the relationship between the sRGB color gamut and the color gamut of an image forming apparatus, a lightness difference is likely to be smaller than a chroma difference. Therefore, by converting a color difference that includes chroma into a lightness difference, it is possible to effectively utilize a narrow color gamut.

Meanwhile, as illustrated in FIG. 7, it is also conceivable that the color 612 thus converted goes out of the color gamut 616. In such a case, a configuration may be taken so as to move the color 612 by color difference minimum mapping to set it to the color 614 in the color gamut 616 and set such the color 614 to be the post-conversion color of the color 601 after color degradation correction. The color difference minimum mapping will be described later with reference to Equations (10) to (14).

In the present embodiment, as illustrated in FIG. 7, an output value for which L607 of the reference color has been inputted to the lightness conversion table is L607 without change. As described above, L610 is an output value for when the lightness L605 of the post-conversion color of the maximum lightness color has been inputted to the lightness conversion table. In the present embodiment, a value for when the lightness of a value greater than L607 and less than L605 is inputted to the lightness conversion table is calculated based on L607 and L610. For example, as illustrated in the graph of FIG. 7, an output value L₂ for when a lightness L₁ greater than L607 and less than L605 is inputted into the lightness conversion table can be calculated by the following Equation (8), which is a lightness conversion function.

$${L}_{2} = L 607 + ( L 610 - L 607 ) \times \frac{{L}_{1} - L 607}{L 605 - L 607} \qquad ( 8 )$$

A table that takes L₁ as input and outputs such a value L₂ is calculated as the lightness conversion table of the light color group. For each color after conversion according to gamut mapping, the lightness thereof is converted using the lightness conversion table, and for a color that needs to be moved, such as the color 614 for the color 612, a color that has been moved will be the color after conversion according to gamut mapping after color degradation correction in the present embodiment.

Here, a lightness conversion function is assumed to be generated as in Equation (8) based on two points but is not particularly limited thereto so long as output of a corresponding lightness is calculated. For example, the parameters of the lightness conversion function may be calculated from three points assuming that the lightness conversion function is a quadratic function.

In the present embodiment, as described above, L607 of the reference color does not change depending on input to the lightness conversion table. With such processing, by maintaining a post-conversion color for a color with the highest chroma, a color difference can be corrected while maintaining chroma. In addition, an output value for when a lightness that is greater than L605 or a lightness that is less than L606 is inputted to the lightness conversion table is assumed to be undefined here as they are not included in the input image data; however, in such a case, calculation may be performed by applying Equation (8), for example.

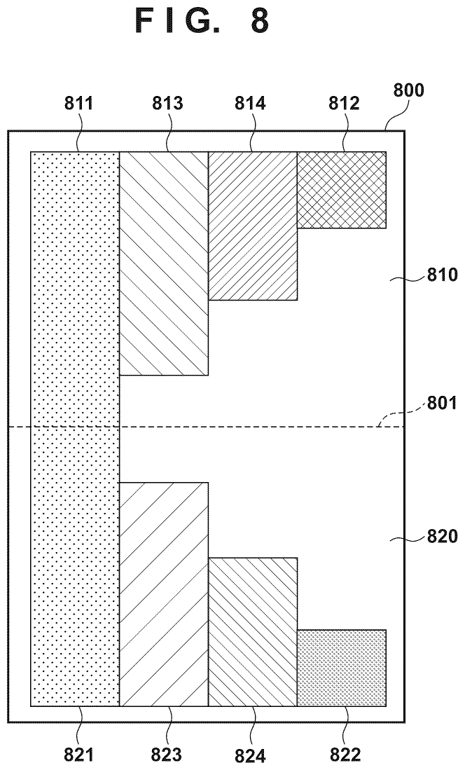

FIG. 8 is a diagram for explaining a whole image that includes the first original data and the second original data according to the present embodiment. A divided image 810 is the first original data, and a divided image 820 is the second original data, and an image 800 is a whole image in which these original data are combined. A boundary 801 is a boundary line between the pieces of original data. Here, the following description will be given assuming that the information processing apparatus 101 first receives the divided image 810 and then receives the divided image 820.

In the divided image 810, objects, each with respective one of a color 811, a color 813, a color 814, and a color 812 in the descending order of lightness, are included as colors, and each is displayed as a rectangular pattern. Further, in the divided image 810, objects, each with respective one of a color 821, a color 823, a color 824, and a color 822 in the descending order of lightness, are included as colors, and each is displayed as a rectangular pattern. Here, it is assumed that the color 811 and the color 821 are the same color. Further, respective colors included in FIG. 8 are included in the hue range 501 of FIG. 5. Further, here, it is assumed that the color 821 corresponds to the color 601 of FIG. 6. Here, it is assumed that a color-degradation-corrected table for the divided image 810 is created as described with reference to FIGS. 6 and 7.

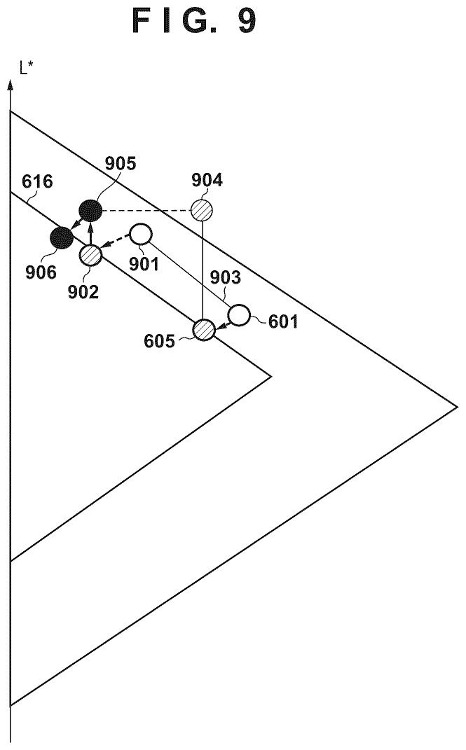

FIG. 9 is a diagram for explaining lightness difference correction performed by the information processing apparatus 101 for the divided image 820 according to the present embodiment. Similarly to FIG. 6, in FIG. 9, the color gamut of the input image data before being subjected to the color conversion processing is indicated as the color gamut 617, and the color gamut after being converted by gamut mapping is indicated as the color gamut 616 on a plane that uses two axes, the L* axis and the C* axis, in the CIE-L*a*b* color space.

Here, description will be given assuming that color degradation occurs only between the color 821 and the color 822 in the divided image 820. In the example of FIG. 9, the color 821 and the color 822 are plotted in the color gamut 617 as the color 601 and a color 901, respectively. In addition, the color 605 and a color 902 are colors in the color gamut 616 after the color 601 and the color 901 have been converted by gamut mapping, respectively. Further, here, it is assumed that the color 601 is the maximum chroma color, and the color 901 is the maximum lightness color. Therefore, the correction amount Mh is a value obtained by multiplying a color difference ΔE 903 between the color 601 and the color 901 by R, and the correction amount Ml is 0.

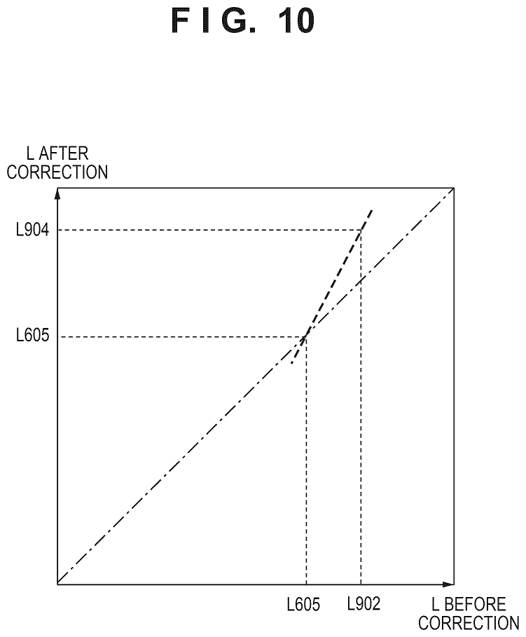

Further, similarly to FIG. 7, FIG. 10 illustrates an example of components for when the lightness conversion table is created for the divided image 820. In the example of FIG. 9, a color 904 is indicated as a color obtained by moving the color 605 by the correction amount Mh in the lightness direction, and a lightness L904 thereof is a value to be outputted when a lightness L902 of the color 902 is inputted to the lightness conversion table illustrated in FIG. 10. Further, regarding the lightness conversion table illustrated in FIG. 10, an output value for when the lightness L605 is inputted is L605. Further, a color 905 and a color 906 of FIG. 9 are colors set based on the color 902 and the color 904 similarly to the color 612 and the color 614 of FIG. 6, respectively.

With such processing, even when divided images are sequentially received, it is possible to perform color degradation correction on each thereof when they are received and map colors to a print color gamut so as to reduce the extent of color conversion caused by color conversion.

Further, when a lightness value that has been outputted by conversion according to the lightness conversion table for the maximum lightness color exceeds the maximum lightness of the color gamut 616 after gamut mapping, the CPU 102 may perform maximum value clipping processing. The maximum value clipping processing according to the present embodiment is processing for subtracting a difference between such an outputted lightness value and the maximum lightness of the color gamut 616 after gamut mapping from the entire output of the lightness conversion table. In this case, the lightness of the maximum chroma color after gamut mapping also changes to the low lightness side. With such processing, even when a unique color included the input image data is skewed to the high lightness side, it is possible to correct the whole so that the lightness tones on the low lightness side are also utilized. Regarding the minimum lightness color, when the minimum lightness after correction is lower than the minimum lightness of the color gamut after gamut mapping, in a case where the lightness value outputted in the conversion according to the lightness conversion table exceeds the minimum lightness of the color gamut 616 after gamut mapping, similar processing can be performed.

The CPU 102 according to the present embodiment corrects the gamut mapping table using the values of the lightness conversion table thus calculated, thereby creating a degradation-corrected table for each hue range. Here, the degradation-corrected table is created by correcting the value of the lightness of output of the gamut mapping table to the value of output of the lightness conversion table for each corresponding input.

In the present embodiment, a lightness conversion table is created for each hue range; however, when processing is performed using a different table for each hue range, it is conceivable that a steep change will occur in the output value depending on whether a boundary of the hue range is crossed. From such a viewpoint, when performing gamut mapping of colors in a given hue range, the CPU 102 may perform processing for converting colors by additionally using the lightness conversion table of one neighboring hue range. The CPU 102 may weight and add a lightness, obtained by converting the lightness of a color in a given hue range using the lightness conversion table for that hue range, and a lightness converted using the lightness conversion table for a neighboring hue range and thereby calculate the lightness of that color after gamut mapping. For example, when performing color conversion of a color C located at a position of a hue angle Hn degrees (here, assumed to be an angle within the hue range 501 of FIG. 5), the CPU 102 can calculate a value Lc of lightness after color conversion as in the following Equation (9).

$$Lc = \vert \frac{Hn - {H}_{502}}{{H}_{502} - {H}_{501}} \vert \times {Lc}_{501} + \vert \frac{Hn - {H}_{501}}{{H}_{502} - {H}_{501}} \vert \times {Lc}_{502} \qquad ( 9 )$$

Here, H501 is an intermediate hue angle of the hue range 501 and H502 is an intermediate hue angle of a hue range 502. Further, Lc501 is a value obtained by converting the lightness of the color C using the lightness conversion table for the hue range 501, and Lc502 is a value obtained by converting the lightness of the color C using the lightness conversion table for the hue range 502. With such processing, by performing conversion of lightness taking into account the lightness conversion table of an adjacent hue range, it is possible to prevent a steep change at the boundary of a hue range in an output value obtained by gamut mapping.

As described above, regarding a color that goes out of the color gamut 616 with color degradation correction in which output lightness of the lightness conversion table is used as is, such as the color 612, the CPU 102 according to the present embodiment converts such value after conversion into a value within the color gamut by color difference minimum mapping. In the example of FIG. 6, the color 612 is converted to the color 614 by color difference minimum mapping as described above. Such color difference minimum mapping will be described below.

For example, the CPU 102 can convert the color 612 to a color that is closest to the color 612 among colors that are within the color gamut 616 and are positioned in a predetermined direction from the color 612, by color difference minimum mapping. A relationship between a weight for setting such a predetermined direction and a distance ΔEw from the color 612 to a color after conversion (here, 614) at that time can be expressed by the following Equations (10) to (14).

$$Δ E = \sqrt{{( {L}_{s} - {L}_{t} )}^{2} + {( {a}_{s} - {a}_{𝔱} )}^{2} + {( {b}_{s} - {b}_{t} )}^{2}} \qquad ( 10 )$$

$$Δ E = \sqrt{{( {L}_{s} - {L}_{t} )}^{2}} \qquad ( 11 )$$

$$Δ E = \sqrt{{( {a}_{s} - {a}_{t} )}^{2} + {( {b}_{s} - {b}_{t} )}^{2}} \qquad ( 12 )$$

$$Δ H = Δ E - ( Δ L + Δ C ) \qquad ( 13 )$$

$$Δ H = Wl \times ΔL + Wc \times Δ C + Wh \times Δ H \qquad ( 14 )$$

Here, a pre-conversion color by color difference minimum mapping is set as (Ls, as, bs), and a post-conversion color is set as (Lt, at, bt). Further, as a weight for setting the above predetermined direction, a weight in the lightness direction is expressed as Wl, a weight in the chroma direction is expressed as Wc, and a weight of the hue angle is expressed as Wh(Wh+Wl+Wc=1). By finding (Lt, at, bt) that satisfies Equation (14), a color after conversion by color difference minimum mapping is determined.

Here, the values of Wl, Wc, and Wh can be set arbitrarily by the user. In the second embodiment, the degradation-corrected table is created such that the change caused by color degradation correction of a post-conversion color occurs only in the lightness direction; therefore, if it is desired to maintain such an effect as much as possible, setting the weight in the lightness direction to be greater than other weights can be considered. Further, a hue has a great effect on color appearance; therefore, by setting the weight of a hue angle to be smaller (e.g., than the weight of the lightness direction and the weight of the chroma direction), it is possible to prevent change in color appearance before and after color degradation correction. For example, color difference minimum mapping can be performed with the relationship of these weights being Wh>Wl>Wc.

The description has been given assuming that, in color difference minimum mapping, the color 614 is searched for from colors located in a predetermined direction from the color 612. However, the processing of converting a color that is positioned outside the color gamut after degradation correction, such as the color 612, to be within the color gamut is not particularly limited thereto. For example, a color, for which the color 612 has been moved to be within the color gamut 616 by a minimum movement distance so as to maintain a distance from the color 607, may be set to be a post-conversion color of the color 601 after color degradation correction, as the color 614.

In the present embodiment, an example in which color degradation correction is performed such that the change caused by the color degradation correction of a post-conversion color is performed only in the lightness direction has been described. Here, as a characteristic of visual perception, sensitivity to a lightness difference varies depending on chroma. For example, the sensitivity is likely to be higher for a lightness difference between colors low in chroma than a lightness difference between colors higher in chroma than such colors. From this point of view, the CPU 102 according to the present embodiment may perform control such that the lightness direction change amount of a post-conversion color by color degradation correction further varies depending on the chroma value. Here, colors are divided into colors with low chroma and colors with high chroma; regarding the colors with high chroma, the processing is performed as described with reference to FIG. 6 and the like, and regarding the colors with low chroma, the processing is performed so as to decrease the lightness direction change amount of a post-conversion color. Such a color determined to have low chroma will be described below in the context of color degradation correction performed so as to decrease the amount of change in the lightness direction.

When correcting the value of lightness of output of the gamut mapping table to the value of output of the lightness conversion table, the CPU 102 sets Lc′, obtained by internally dividing a lightness value Ln before such correction and a lightness value Lc after such correction by a chroma correction ratio S, as the value of lightness of output of the degradation-corrected table. The chroma correction ratio S is calculated by the following Equation (15) using a chroma value Sn of an output value of gamut mapping and a maximum chroma value Sm of the color gamut after gamut mapping in a hue angle of the output value of gamut mapping. Further, Lc′ is calculated by the following Equation (16).

$$S = \frac{Sn}{Sm} \qquad ( 15 )$$

$${Lc}^{′} = S \times Lc + ( 1 - S ) \times Lc \qquad ( 16 )$$

Here, a condition for when dividing colors into low chroma and high chroma is not particularly limited and can be arbitrarily set according to the user or the environment. For example, a configuration may be taken so as to set a predetermined threshold for chroma and set chroma that is greater than or equal to the threshold as high chroma and chroma less than the threshold as low chroma. Further, a configuration may be taken so as to set the bottom half of detected chroma to be low chroma and the rest to be high chroma, for example. The CPU 102 may perform color degradation correction so as to zero the amount of change in a post-conversion color for a color with low chroma.

With such processing, it is possible to perform color degradation correction that accords with visual sensitivity and prevent a state in which the level of correction is too strong. For example, it is possible to prevent a change due to color degradation correction for colors on a gray axis, for example.

### Third Embodiment

### [Different Hue Repulsive Force]

Even if colors exist in different hue ranges, when a lightness difference becomes small after gamut mapping, it may be difficult to distinguish them. From such a viewpoint, when a lightness difference between two colors after gamut mapping decreases to a predetermined threshold (color difference ΔE) or less, the information processing apparatus 101 according to the present embodiment can perform color degradation correction so as to increase such a lightness difference.

The information processing apparatus 101 according to the present embodiment can perform similar color degradation correction processing to the first embodiment. Differences in the color degradation correction processing performed by the information processing apparatus 101 between the present embodiment and the first embodiment will be described below. The color degradation correction processing to be described below can be similarly executed on either of the first divided image and the second divided image.

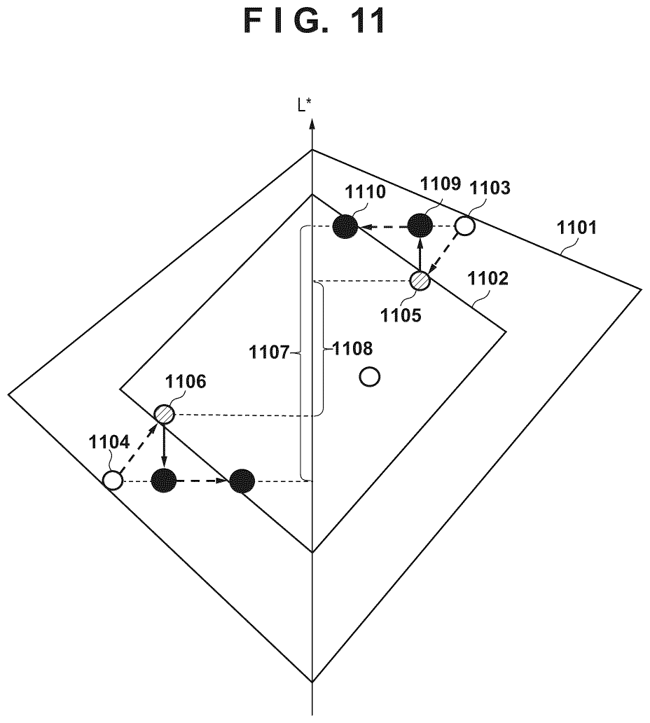

An example of processing for determining whether lightness degradation occurs, performed in step S202 by the information processing apparatus 101 according to the present embodiment, will be described below with reference to FIG. 11. In the present embodiment, as described above, it is assumed that a lightness difference between two colors after gamut mapping decreasing to a predetermined color difference ΔE or less is referred to as lightness degradation. Further, the CPU 102 according to the present embodiment determines that color degradation occurs when lightness degradation occurs.

In step S202, the CPU 102 detects a combination of colors in which lightness degradation occurs among the combinations of unique colors included in the image data based on the unique color list detected in step S201. In FIG. 11, the color gamut of the input image data before being subjected to the color conversion processing is indicated as a color gamut 1101, and the color gamut after being converted by gamut mapping is indicated as a color gamut 1102 on a plane that uses two axes, an L* axis and a C* axis, in the CIE-L*a*b* color space. The input image data includes a color 1103 (first color) and a color 1104 (second color), which are illustrated in the color gamut 1101. A color 1105 and a color 1106 are colors in the color gamut 1102. The color 1105 is a color for when gamut mapping has been performed on the color 1103, and color 1106 is a color for when gamut mapping has been performed on the color 1104. The processing to be described below is repeated for all combinations of unique colors included in the image data.

Here, the CPU 102 determines that a lightness difference has decreased when a lightness difference 1108 between color 1105 and color 1106 is smaller than a lightness difference 1107 between color 1103 and color 1104. Here, it is assumed that a lightness difference in the CIE-L*a*b* color space is calculated. The color information in the CIE-L*a*b* color space is represented using a color space with three axes, L*, a*, and b*. The color 1103 is represented using L1103, a1103, and b1103. The color 1104 is represented using L1104, a1104, and b1104. The color 1105 is represented using L1105, a1105, and b1105. The color 1106 is represented using L1106, a1106, and b1106. When the input image data is represented by another color space, the input image data may be converted to the CIE-L*a*b* color space by a known color space conversion technique, and subsequent processing may be performed as is in that color space. The lightness difference ΔL 1107 and the lightness difference ΔL 1108 are calculated by the following Equations (17) and (18), for example.

$$Δ {L}_{807} = \sqrt{{( {L}_{803} - {L}_{804} )}^{2}} \qquad ( 17 )$$

$$Δ {L}_{808} = \sqrt{{( {L}_{805} - {L}_{806} )}^{2}} \qquad ( 18 )$$

When the lightness difference ΔL 1108 is smaller than the lightness difference ΔL 1107, the CPU 102 determines that the lightness difference has decreased. Further, when the lightness difference ΔL 1108 is less than or equal to a predetermined threshold, the CPU 102 determines that these colors do not have a difference with which it is possible to distinguish a difference between the colors and thus lightness degradation has occurred.

If the lightness difference between the color 1105 and the color 1106 is a magnitude at which the colors can be distinguished to be different in terms of characteristics of visual perception of humans, it can be determined that there is no need to correct the lightness difference. From such a viewpoint, the threshold used here may be, for example, 0.5. When the lightness difference ΔL 1108 is smaller than the lightness difference ΔL 1107 and when the lightness difference ΔL 1108 is smaller than 0.5, the CPU 102 may determine that lightness degradation has occurred.

Next, the color degradation correction processing performed in step S205 according to the present embodiment will be described with reference to FIG. 11.

The CPU 102 according to the present embodiment can calculate a correction ratio T, which is a reflection rate of correction of the conversion parameter in color degradation correction, based on a ratio of the number of combinations of colors in which lightness degradation occurs to the total number of combinations of colors in the unique color list. For example, the CPU 102 according to the present embodiment calculates the correction ratio T as follows.

T=number of combinations of colors in which lightness degradation occurs/number of combinations of colors in unique color list

The above correction ratio T decreases as a proportion of the combinations of colors in which lightness degradation occurs within the unique color list decreases and increases as the proportion increases. By performing correction of the conversion parameter using such a correction ratio, it is possible to increase the level of correction of color degradation as the proportion of the combinations of colors in which lightness degradation occurs increases.

Next, the CPU 102 performs lightness difference correction based on lightness before gamut mapping and the correction ratio T. The lightness Lc after lightness difference correction can be calculated by, for example, the following Equation (19) as a value obtained by internally dividing a gap between the lightness Lm before gamut mapping and the lightness Ln after gamut mapping by the correction ratio T.

$$Lc = T \times ( Lm - Lc ) + Ln \qquad ( 19 )$$

Such lightness difference correction is repeated for all the unique colors in the input image data. In FIG. 11, the lightness L1105 of the color 1105 is subjected to lightness difference correction using the correction ratio T, and a result of that correction is indicated as a color 1109. In the example of FIG. 11, the color 1109 is outside of the color gamut 1102 after gamut mapping and thus is mapped to the color gamut 1102 and becomes a color 1110. Similar processing is performed on the color 1104. With such processing, it is possible to perform gamut mapping in which the lightness difference is widened for colors included in the image data, and in a case where lightness degradation occurs, it is possible to reduce the extent thereof. Therefore, by preventing a state in which the lightness difference after gamut mapping becomes too small, it is possible to reduce a decrease in distinguishability.

The processing for reducing lightness degradation according to the present embodiment may be performed simultaneously with the processing according to the second embodiment. In that case, the lightness difference correction processing is performed on the reference color of the color degradation correction processing. In conjunction with correcting the lightness difference of the reference color, lightness difference correction of other colors can also be processed. With such a configuration, when performing color degradation correction, it is possible to reduce the extent of lightness degradation in addition to the extent of color degradation.

### Fourth Embodiment

### [Referencing of Processed Correction Values]

In the first to third embodiments, an example in which a color-degradation-corrected table is separately generated for each of the first divided image and the second divided image has been described. However, when a color-degradation-corrected table is separately generated for each divided image, even if colors are common among the divided images, the colors may appear to be different after their respective color conversion processing.

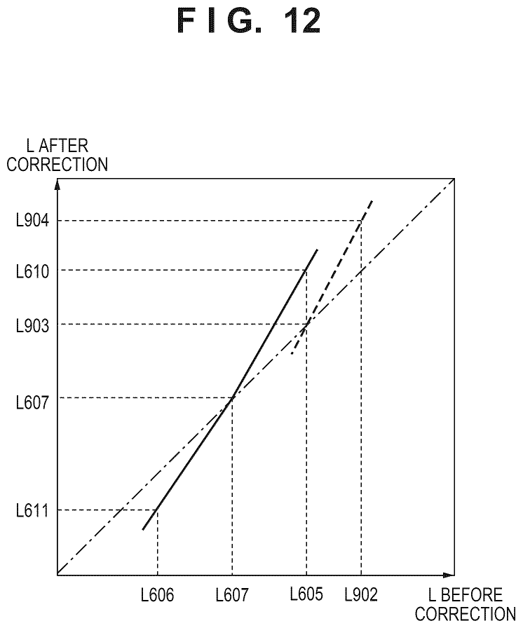

A case where the same color appears to be different colors as a result of color degradation correction being performed separately among divided images will be described below. FIG. 12 is a diagram for explaining an example of a lightness conversion table for each divided image for when color degradation correction that results in colors that are the same among divided images appearing to be different colors is performed.

FIG. 12 represents the lightness conversion table (first lightness conversion table) described in FIG. 7 and the lightness conversion table (second lightness conversion table) described in FIG. 10 of the second embodiment. Here, the first lightness conversion table is for the first divided image, and the second lightness conversion table is for the second divided image.

Here, when L605 is inputted to the first lightness conversion table, L610 is outputted, and when L605 is inputted in the second lightness conversion table, L903 is outputted. Therefore, for example, when the image 800, which includes the first divided image 810 and the second divided image 820 illustrated in FIG. 8, is inputted, the lightnesses of the post-conversion colors of the color 811 and the color 821, which are the same color, will be different with the boundary 801 as the boundary. In particular, when an object with the color 811 and an object with the color 821 are continuous in the original such as in the image 800, such a difference between the post-conversion colors is more easily recognizable.

To reduce such a sense of incongruity, the information processing apparatus 101 according to the present embodiment uses a conversion parameter that has been set for the first divided image for a portion of a conversion parameter, which includes values of the color-degradation-corrected table for the second divided image received subsequent to the first divided image.

For example, a case where a color (third color) that is common between the first divided image and the second divided image is included and the third color is converted to the fourth color according to the color-degradation-corrected table for the first divided image will be considered. In such a case, the information processing apparatus 101 corrects the conversion parameter (color-degradation-corrected table) so as to convert the third color to the fourth color when performing color degradation correction processing for the second divided image.

The information processing apparatus 101 according to the present embodiment sets, as a fixed color, a color included in common between the first divided image and the second divided image. The information processing apparatus 101 corrects the conversion parameter such that a color sets as a fixed color will be converted to the same color between the color-degradation-corrected table (first table) for the first divided image and the color-degradation-corrected table (second table) for the second divided image. Here, it is assumed that a color included in common between the first divided image and the second divided image is set as a fixed color; however, for example, a configuration may be taken so as to set, as a fixed color, a color of an object that continues across a boundary portion between the first divided image and the second divided image in an image for when a whole image is outputted.

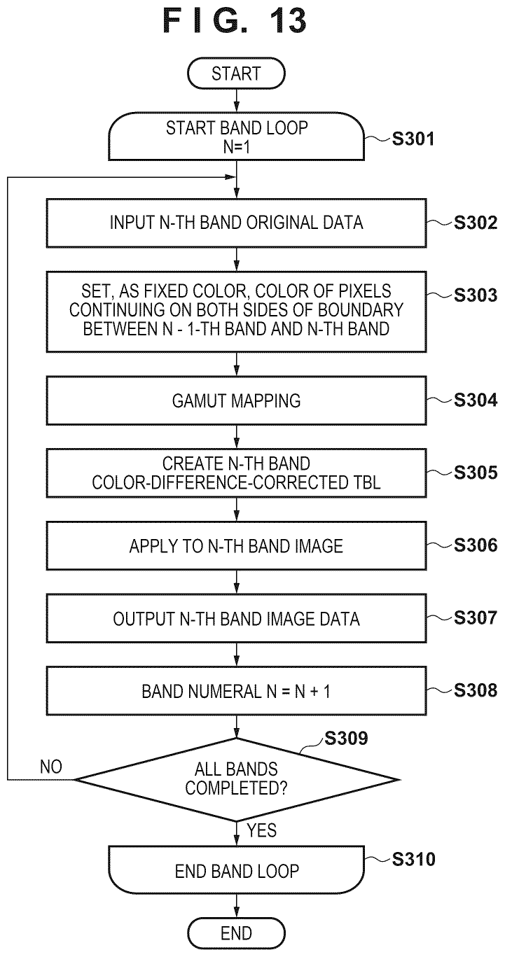

FIG. 13 is a flowchart for explaining an example of the overall processing to be performed by the information processing apparatus 101 according to the present embodiment. Regarding the processing indicated in FIG. 13, loop processing of steps S302 to S309 is repeated on divided images obtained by dividing a whole image into band (unit print area) units. Here, the following description will be given assuming that a whole image is divided in to M divided images with band numerals N=1 to M and the divided images are received by the information processing apparatus in order starting with that with the smallest band numeral. It is assumed that the processing indicated in FIG. 13 is started upon reception of a divided image. Further, description will be omitted for the processing of FIG. 13 to be performed in a manner similar to that of FIG. 2.

In step S301, the CPU 102 sets the initial value of the band numeral N to be processed to 1. Regarding the loop processing of step S302 to S309, different processes are performed for when N=1 and for when that is not the case. First, processing to be executed for when N=1 will be described.

In step S302, the CPU 102 obtains a divided image with the band numeral to be processed. Here, similarly to step S101, the CPU 102 obtains data of an image.

In step S303, the CPU 102 sets, as a fixed color, a color that continues across a boundary portion between (or is included in common between) a divided image with the band numeral N, which is the current processing target, and a divided image with the band numeral N−1. This processing is not performed when N=1.

In step S304, the CPU 102 performs color conversion processing on the divided image to be processed. Step S304 is performed similarly to step S102. In step S305, the CPU 102 creates a color-degradation-corrected table for the divided image to be processed. When N=1, step S305 is performed similarly to step S103. The processing of step S305 for when N=1 is not the case will be described later.

In step S306, the CPU 102 generates color-degradation-corrected image data in which color degradation has been corrected, using the color-degradation-corrected table created in step S305, with the divided image obtained in step S302 as input. Step S306 is performed similarly to step S104. In step S307, the CPU 102 outputs the color-degradation-corrected image data stored in step S306 from the information processing apparatus 101 through the transfer I/F 106.

In step S308, the CPU 102 increments the band numeral N of the processing target by 1. In step S309, the CPU 102 determines whether all the band numerals have been set as a processing target. If all of the band numerals have been set as a processing target, the processing proceeds to step S310, the band loop processing of steps S302 to S309 is terminated, and the processing of FIG. 13 is terminated. If not all of the band numerals have been set as a processing target, the processing returns to step S302.

The processing from steps S303 to S305 for when N is 2 or more (from the second loop onward of the band processing) will be described below. In step S303, the CPU 102 sets, as a fixed color, a color included in common between the second divided image and the first divided image. In the example of FIG. 8, the color 811 and the color 821 are continuous across the boundary 801, and so, the color thereof is set as a fixed color. Even when N=2 or more, step S304 is performed similarly to step S102.

In step S305, the CPU 102 creates the second table such that, for the second divided image, the post-conversion color of the fixed color will be the same as the post-conversion color according to the first table. Here, a color-degradation-corrected table generated by processing described with reference to FIG. 3 in which, regarding the second table, the post-conversion color of the fixed color is fixed to the post-conversion color according to the first table and the post-conversion colors of other colors are changed is the second table.

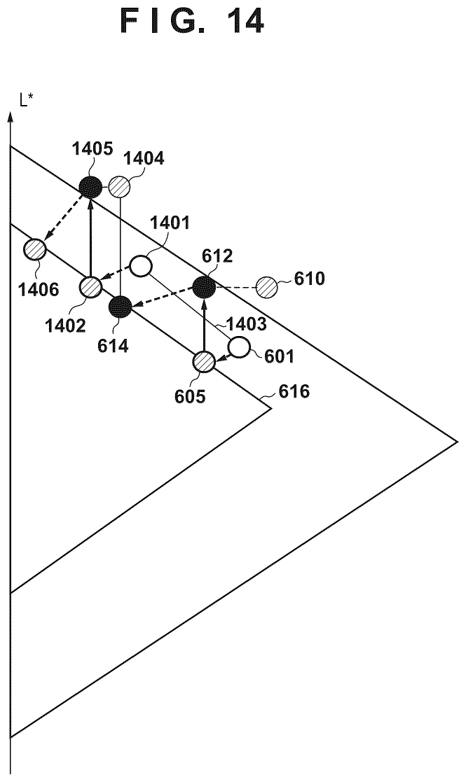

FIG. 14 is a diagram for explaining processing for creating a color-degradation-corrected table for when a color set as a fixed color is included in the second divided image. Similarly to FIG. 6, in FIG. 14, the color gamut of the input image data before being subjected to the color conversion processing is indicated as the color gamut 617, and the color gamut after being converted by gamut mapping is indicated as the color gamut 616 on a plane that uses two axes, the L* axis and the C* axis, in the CIE-L*a*b* color space. Further, the colors 601 and 1401 included in the second divided image are plotted in the color gamut 617. In addition, a color 1402 is a color in the color gamut 616 after the color 1401 has been converted by gamut mapping. In FIG. 14, the color 601 is indicated as a fixed color. Further, a color-degradation-corrected table according to which conversion such as that illustrated in FIG. 6 is performed is created for the first divided image. Therefore, in FIG. 14, what the color 601 is ultimately converted to is the color 614, which is the same as in FIG. 6.

Further, in FIG. 14, it is assumed that the color 601 is the maximum chroma color, and the color 1401 is the maximum lightness color. Therefore, the correction amount Mh is a value obtained by multiplying a color difference ΔE 1403 between the color 601 and the color 1401 by R, and the correction amount Ml is 0.

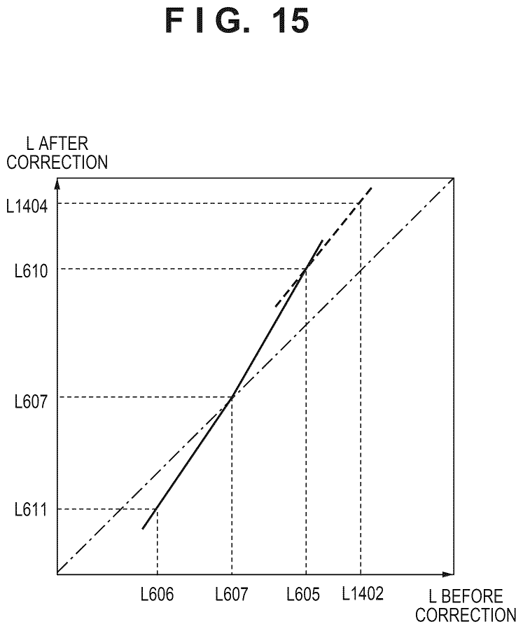

In FIG. 14, a lightness conversion function is generated as described with reference to FIGS. 6 and 7, and post-conversion colors of respective colors including the color 1401 for when the second table is used are determined. FIG. 15 is a graph illustrating an example of components for when a lightness conversion table is created for the second divided image indicated in FIG. 14. In FIG. 15, the lightness conversion table for the second divided image is indicated with a dashed line, and the lightness conversion table for the first divided image is indicated with the same solid line as indicated in FIG. 7. That is, in FIG. 15, the lightnesses of input colors in the lightness conversion table are indicated on the horizontal axis, and the lightnesses to be outputted are indicated on the vertical axis, and the slope of the lightness conversion function is calculated such that when the lightness L605 is inputted, L610 is outputted, and when a lightness L1402 of the color 1402 is inputted, L1404 is outputted.

Here, the lightness L1404 of a color 1405 is a value to be outputted when L1402 is inputted to the lightness conversion table and is a value obtained by adding the correction amount Mh to L614. In FIG. 14, a color obtained by thus moving the color 614 in the lightness direction by the correction amount Mh is indicated as the color 1404, and a color obtained by moving the post-conversion color 1402 of the color 1401 in the lightness direction so as to have such lightness L1404 is the color 1405. Further, here, the color 1405 has gone out of the color gamut 616, and so, the color 1405 is moved to be a color 1406 in the color gamut by processing similar to that in which the color 612 is moved to be the color 614 in FIG. 6, and the second table is created such that such a color 1406 is set as the post-conversion color of the color 1401 after color degradation correction.

Further, here, lightness components in the first table are indicated in FIG. 7, and lightness components in the second table are indicated in FIG. 15. In either of these, a value to be outputted when L605 is inputted is L610, and when divided images having a common color are inputted separately, that color will be outputted as the same color.

With such processing, when the first divided image and the second divided image including a common color are inputted, for such a common color, it is possible to carry over a value of the color-degradation-corrected table for the first divided image for that for the second divided image. Accordingly, it is possible to reduce occurrence of a sense of incongruity in which the post-conversion color becomes different for a color that is common between the first divided image and the second divided image. Further, when performing the lightness difference correction processing described in the third embodiment, by setting the correction ratio T to 0 for a fixed color, it is possible to reduce the extent of color compression while maintaining the fixed color.

Here, an example in which only one color is set as a fixed color has been described, but two or more fixed colors may be set. Considering that in such a case, it becomes increasingly difficult to implement color degradation correction itself as the fixed colors increase, the number of fixed colors may be limited to a predetermined threshold, for example. Further, when the number of colors that satisfy a condition for a fixed color exceeds the predetermined threshold, fixed colors may be selected in an order that satisfies a predetermined condition, such as “descending order of their pixel count in the divided image” or “descending order of their pixel count among all the pixels including previously processed divided images”, for example. Further, the information processing apparatus 101 may select a fixed color from among colors for which a predetermined number of pixels or more are included in the divided image. With such processing, by using a plurality of fixed colors, it is possible to further reduce occurrence of a sense of incongruity among divided images.

### Fifth Embodiment

### [Consideration of Unprocessed Correction Values]

When there is a color that is common between the first divided image and the second divided image, the information processing apparatus 101 according to the fourth embodiment sets that color as a fixed color and creates the second table. Meanwhile, the lightness conversion function of the second table indicated with a dashed line in FIG. 15 has a smaller slope (i.e., lower level of color degradation correction) than the lightness conversion function of the first table indicated with a solid line. Further, values after conversion according to the second table have greater overall lightness than values after conversion according to the first table. This is because when the first table is created, L605 is corrected to be L610 so to be made lighter, and that being reflected in the second table has made it necessary to correct for further lightness. In particular, this occurs due to the first table being created independently of the second table, with a color that is not present in the second divided image as a reference color.

From such a viewpoint, the information processing apparatus 101 according to the present embodiment estimates a color (common color) that is included in common in the second divided image among colors included in the first divided image and uses such a color that is included in common as a reference color to create the color-degradation-corrected table for the first divided image. The information processing apparatus 101 can, for example, estimate, as a common color, a color at the boundary portion, adjacent to the second divided image received in succession to the first divided image, of the first divided image. Here, similarly to the above embodiments, it is assumed that the second divided image is a divided image that is received subsequent to the first divided image; however, the second divided image may be a divided image received immediately before the first divided image. Further, a configuration may be taken such that when a reference color is set in the first divided image, a color-degradation-corrected table is created with the same color as the reference color for the second divided image received subsequent to the first divided image.

Further, the information processing apparatus 101 may estimate, as such a common color, a color that is included in colors at a boundary portion continuing from a third divided image received immediately before the first divided image among colors of the first divided image that are at a boundary portion adjacent to the subsequently received second divided image. Here, it is assumed that a color at a boundary portion adjacent to another divided image refers to a color of a one-pixel-wide line at an outermost edge portion; however, the boundary portion may have a width of two or more pixels.

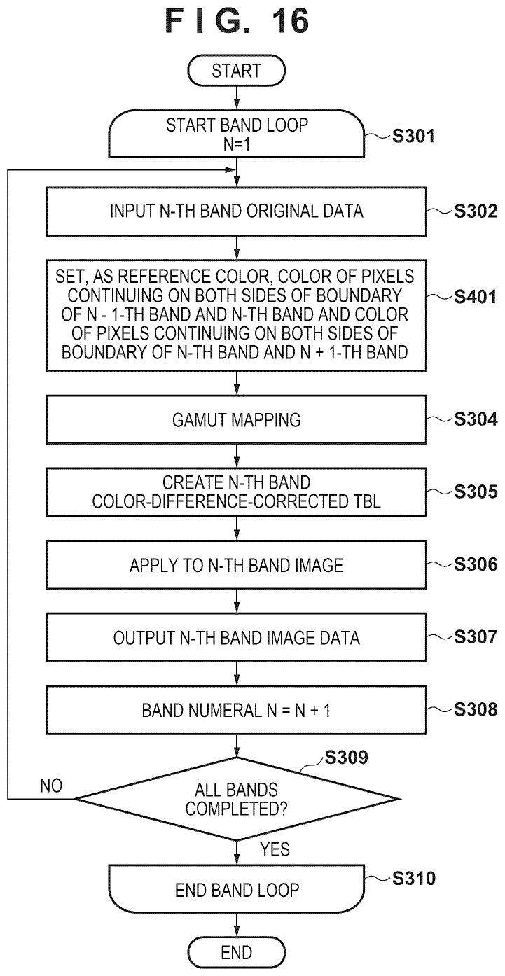

FIG. 16 is a flowchart for explaining an example of the overall processing to be performed by the information processing apparatus 101 according to the present embodiment. The processing indicated FIG. 16 is performed similarly to that indicated in FIG. 13 except for step S303 being step S401, and so, redundant description will be omitted.

In step S401, the CPU 102 sets, as a reference color, a color of a boundary portion, adjacent to a divided image received in succession to a divided image divided image to be processed, of that divided image. Here, it is assumed that the CPU 102 sets, as a reference color, a color of a divided image with a band numeral N that is a color of its boundary portion with a divided image with a band numeral N−1 and is a color of its boundary portion with a divided image with a band numeral N+1. Further, when N=1, a color of a boundary portion between the divided image with the band numeral N and the divided image with the band numeral N+1 is set as the reference color. When there a plurality of colors that satisfy such a condition, the color with the greatest chroma thereamong may be set as the reference color, for example. Further, to avoid a background color being selected as the reference color, a configuration may be taken so as to set a predetermined range of colors to be determined as background colors and set the reference color from colors from which such a predetermined range has been excluded.

In the example of FIG. 8, the divided image 810 is the first divided image, and the divided image 820 is the second divided image. Further, a color of pixels of an object present at the boundary 801, which is the boundary portion adjacent to the divided image 820, in the divided image 810 is only the color 811, and so the color 811 is set as the reference color.

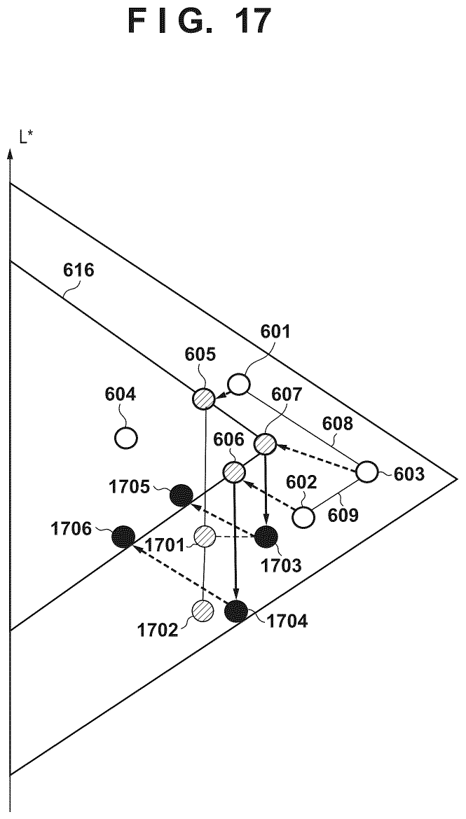

FIG. 17 is a diagram for explaining processing for creating a color-degradation-corrected table for when a color of a boundary portion with an adjacent divided image is set as a reference color for a divided image. In FIG. 17, the color 601 to the color 604, which are similar to those indicated in FIG. 6, are plotted on a plane that uses two axes, the L* axis and the C* axis, in the CIE-L*a*b* color space. In the example of FIG. 17, the color 601 is set as the reference color, different from the example described with reference to FIG. 6. In this example, the correction amount Mh is a value obtained by multiplying the color difference ΔE 608 between the color 601 and the color 603 by R, and the correction amount Ml is a value obtained by multiplying the color difference ΔE 609 between the color 603 and the color 602 by R.

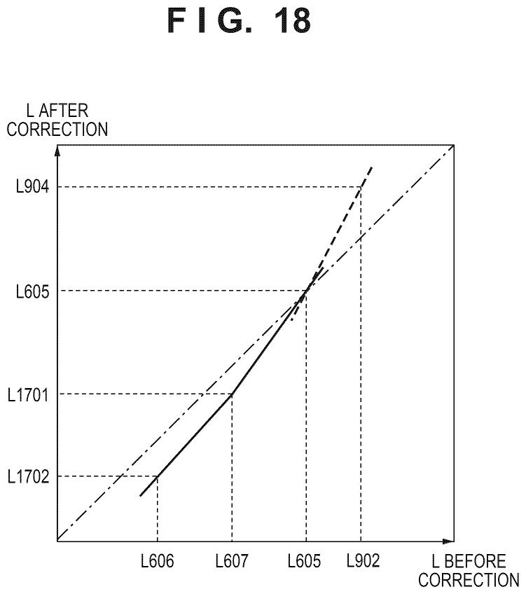

In FIG. 17, a lightness conversion function is generated as described with reference to FIGS. 6 and 7, and post-conversion colors for when a color-degradation-corrected table is used are determined. FIG. 18 is a graph illustrating, with a solid line, an example in which components for when the lightness conversion table is created for the divided image indicated in FIG. 17 with the color 601 as the reference point. In FIG. 18, the lightnesses of input colors in the lightness conversion table are indicated on the horizontal axis, and the lightnesses to be outputted are indicated on the vertical axis.

In the examples of FIGS. 6, 9, and 14, the lightness conversion function has been created such that the lightness L of the maximum lightness color after correction is the lightness L of the maximum chroma color before correction+Mh (lightness L of the minimum lightness color after correction is the lightness L of the maximum chroma color before correction−Ml).

However, in FIG. 17, the color 601, which is the maximum lightness color, is set as the reference color; therefore, the lightness conversion function is created such that the lightness L of the maximum chroma color after correction is the lightness L of the maximum lightness color before correction-Mh, and the lightness L of the minimum lightness color after correction is the lightness L of the maximum lightness color before correction-Mh-Ml.

Further, it is assumed that when the color 602, which is the minimum lightness color, is set as the reference color, the lightness conversion function is created such that the lightness L of the maximum chroma color after correction is the lightness L of the minimum lightness color before correction+Mh, and the lightness L of the maximum lightness color after correction is the lightness L of the minimum lightness color before correction+Mh+Ml. Regardless of whether the color 601 or the color 602 is set as the reference color, the lightness L of the maximum lightness color after correction is the lightness L of the maximum chroma color after correction+Ml, and the lightness L of the minimum lightness color after correction is the lightness L of the maximum chroma color after correction-Ml.

Further, when the reference color is a color with a lightness between those of the maximum (minimum) lightness color and the maximum chroma color, the lightness conversion function may be separately generated for a lightness range from the maximum (minimum) lightness color to the reference color and a lightness range from the reference color to the maximum chroma color.

In FIG. 18, regarding input that is L607 or less, the slope of the lightness conversion function is calculated such that when L606 is inputted, L1702 is outputted, and when L607 is inputted, L1701 is outputted. Further, regarding input that is L607 or more, the slope of the lightness conversion function is calculated such that when L607 is inputted, L1701 is outputted, and when L605 is inputted, L605 is outputted. Further, similarly, components of the lightness conversion table created for the second divided image with the color 601 as the reference color are indicated with a dashed line in FIG. 18.

As illustrated in FIG. 18, the post-conversion lightness of the color 601, which used to be converted to L605 before color degradation correction, is L605 after color degradation correction and is common between the first divided image and the second divided image. Further, when compared with the example indicated in FIG. 15, the values of the slopes between the lightness conversion function for the first divided image and the lightness conversion function for the second divided image are closer, and a difference in change of overall lightness has decreased. By thus estimating a common color that is also included in the second divided image from colors included in the first divided image and creating a color-degradation-corrected table with such a common color as the reference color, it is possible to reduce a difference in color degradation correction between the first divided image and the second divided image and reduce a sense of incongruity after conversion.

Further, in this case, when performing the lightness difference correction processing described in the third embodiment, by setting the correction ratio T to 0 for the reference color, it is possible to reduce the extent of color compression while maintaining the fixed color.

The processing for estimating a common color is not particularly limited thereto so long as a color that is highly likely to be included in a successive divided image is estimated as a common color. For example, a configuration may be taken such that the information processing apparatus 101 starts the processing for creating a color-degradation-corrected table for the first divided image after obtaining the second divided image and thereby obtains color information included in the second divided image and then selects a color that is common between the first divided image and the second divided image. Further, for example, a configuration may be taken such that when there is a color that represents a predetermined proportion (e.g., 80%) of pixels relative to a total number of pixels of the first divided image, the information processing apparatus 101 estimates such a color as a common color.

### Sixth Embodiment

When there is a color that is common in the first divided image and the second divided image, the information processing apparatus 101 according to the fourth embodiment sets that color as a fixed color and creates the second table. When such setting of a fixed color is performed, for example, it is conceivable that while a fixed color is converted to a color that is common among divided images, colors that are not a fixed color are converted differently, and as a result, a sense of incongruity may occur.

From such a viewpoint, the information processing apparatus 101 according to the present embodiment generates a third parameter to be used in color conversion processing for the second divided image based on a parameter (hereinafter, first parameter) included in a color-degradation-corrected table created based on color information in the first divided image and a parameter (hereinafter, second parameter) included in a color-degradation-corrected table created based on color information in the second divided image.

For example, the information processing apparatus 101 may generate a third conversion parameter such that a post-conversion color obtained by using the third parameter is determined based on a post-conversion color obtained by using a first conversion parameter and a post-conversion color obtained by using a second conversion parameter. In particular, the information processing apparatus 101 can generate the third parameter such that a seventh color obtained by converting a sixth color in a first pixel position (position in raster units) of the second divided image based on the third parameter is a color obtained by weighting, using weights set for each pixel position of the second divided image, and adding an eighth color obtained by converting the sixth color using the first conversion parameter and a post-conversion color of a ninth color obtained by converting the sixth color using the second conversion parameter.

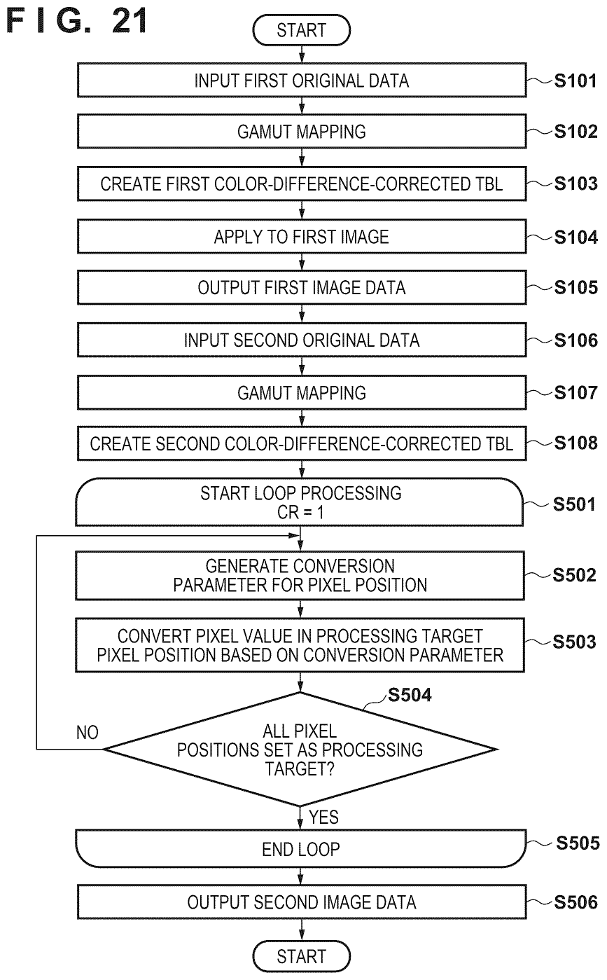

Such processing will be described below with reference to FIG. 21.

FIG. 21 is a flowchart for explaining an example of the overall processing to be performed by the information processing apparatus 101 according to the present embodiment. The processing indicated FIG. 21 is performed similarly to that indicated in FIG. 2 of the first embodiment except for steps S501 to S506 being performed after step S108, and so, redundant description will be omitted. In the present embodiment, the following description will be given assuming that the color-degradation-corrected table based on the color information of the first divided image created in step S103 is referred to as the first table and the color-degradation-corrected table based on the color information of the second divided image created in step S108 is referred to as the second table.

In step S501, the CPU 102 starts the loop processing of steps S502 to S504 with one pixel position of the second divided image as the processing target. Here, it is assumed that an image on the upper left end of the second divided image is set as the processing target.

In step S502, the CPU 102 generates a conversion parameter for the processing target pixel position based on the first parameter and the second parameter. Here, the CPU 102 generates a conversion table (third parameter) for each position that takes a respective color as input and outputs what has been obtained by weighting, using weights set for each pixel position, and adding a post-conversion color obtained by converting the respective color using the first parameter and a post-conversion color obtained by converting the respective color using the second parameter. Regarding such a conversion table, when a total number of rasters of the second divided image is NR and the pixel position of the raster that is the current processing target is CR, for example, a third parameter Table CR [Rin] [Gin] [Bin] can be created as in Equation (20) below.

$$TableCR [ Rin ] [ Gin ] [ Bin ] = ( ( NR - CR ) \times Table 1 [ Rin ] [ Gin ] [ Bin ] + CR \times Table 2 [ Rin ] [ Gin ] [ Bin ] ) \div NR \qquad ( 20 )$$

Here, the pixel position CR is counted, starting from the pixel on the upper left end as 1, incrementing by 1 with each move to the right, and assuming that the next pixel position for when the right end is reached is the left end one row below. Further, it is assumed that a divided image is a group of images continuously arranged in a downward direction from the top.

With such a table, it is possible to set, for each pixel position of the second divided image, a weight so as to increase the weight for the ninth color in a weighted sum in which the above eighth color (Table 1 [Rin] [Gin] [Bin]) and ninth color (Table 2 [Rin] [Gin] [Bin]) are used as its distance to the boundary portion between the first divided image and the second divided image increases.

By performing conversion according to such a conversion parameter for each pixel position, it is possible to obtain, in the upper end portion (boundary portion with the first divided image) of the second divided image, a conversion result that is close to a conversion result obtained by using the first parameter; obtain, in the lower end portion of the second divided image, a conversion result close to a conversion result obtained by using the second parameter; and obtain, in the intermediate portion thereof, a conversion result influenced by both the first conversion parameter and the second conversion parameter. As a result, it is possible to prevent a drastic change in a post-conversion color between adjacent pixel positions and perform conversion for which the human eye is less likely to perceive a sense of incongruity.

In step S503, the CPU 102 converts the pixel value of the processing target pixel position of the second divided image based on the conversion parameter generated in step S502. The converted pixel value generated here is stored in the RAM 103 or the storage medium 104 together with the information of pixel position.

In step S504, the CPU 102 determines whether all of the pixel positions of the second divided image have been set as a processing target. The CPU 102, if all of the pixel positions have been set as a processing target, advances the processing to step S505 and, otherwise, sets the next pixel position as the processing target (+1 to CR) and returns the processing to step S502.

In step S505, the CPU 102 reproduces the converted second divided image from the pixel value of each pixel position stored in step S503 and outputs it from the information processing apparatus 101 via the transfer I/F 106.

With such processing, it is possible to generate, for each pixel position, a conversion parameter to be used for converting the second divided image, using the conversion parameter based on the color information of the first divided image and the conversion parameter based on the color information of the second divided image, and convert the second divided image. Therefore, it is possible to perform color conversion for the second divided image more naturally in relation to the first divided image.

Here, description has been given assuming that the third parameter is calculated according to a weighted sum in which a weight set for each pixel position is used; however, processing is not particularly limited to the above so long as the post-conversion color of the second divided image is calculated based on the above eighth color and ninth color. Further, the conversion parameter may be generated for each RGB component such that the respective post-conversion RGB values are, for example, Rout, Gout, and Bout below.

$$R 1 = Table 1 [ Rin ] [ Gin ] [ Bin ] [ 0 ]$$

$$G 1 = Table 1 [ Rin ] [ Gin ] [ Bin ] [ 1 ]$$

$$B 1 = Table 1 [ Rin ] [ Gin ] [ Bin ] [ 2 ]$$

$$R 2 = Table 2 [ Rin ] [ Gin ] [ Bin ] [ 0 ]$$

$$G 2 = Table 2 [ Rin ] [ Gin ] [ Bin ] [ 1 ]$$

$$B 2 = Table 2 [ Rin ] [ Gin ] [ Bin ] [ 2 ]$$

$$Rout = ( ( NR - CR ) \times R 1 + CR \times R 2 ) \div R 1$$

$$Gout = ( ( NR - CR ) \times G 1 + CR \times G 2 ) \div R 1$$

$$Bout = ( ( NR - CR ) \times B 1 + CR \times B 2 ) \div R 1$$

With such processing, it is possible to obtain a conversion parameter to be used for the second divided image in a gradual manner for each position and obtain a conversion result for which the human eye is less likely to perceive a sense of incongruity.

Here, a conversion parameter is generated according to Equation (20) with all the pixel position in the second divided image as processing targets. However, cases such as that where there is a frame portion in the second divided image and a natural change in color such as that above is not required for what is below a certain height is conceivable. From such a viewpoint, a configuration may be taken so as to perform color conversion according to the conversion parameter calculated according to Equation (20) in pixel positions with CR in a predetermined range, for example, and perform color conversion in which the second table is used in other pixel positions.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-002044, filed Jan. 10, 2024, and Japanese Patent Application No. 2024-174533, filed Oct. 3, 2024, which are hereby incorporated by reference herein in their entirety.

What is claimed is:

1. An information processing apparatus comprising:
a receiving unit configured to receive, from an apparatus configured to sequentially transmit respective divided images into which an image has been divided, a divided image;
an obtaining unit configured to obtain, from a first divided image received by the receiving unit, color information of a first color defined in a first color gamut and color information of a second color defined in the first color gamut;
a conversion unit configured to perform first color conversion processing for converting the first color into a third color defined in a second color gamut different from the first color gamut and converting the second color into a fourth color defined in the second color gamut; and
a first correction unit configured to, in a case where a color difference between the third color and the fourth color is smaller than a predetermined threshold, correct the conversion parameter for the first color conversion processing such that a color difference between a fifth color obtained by converting the first color into a color defined in the second color gamut and the fourth color is greater than the color difference between the third color and the fourth color,
wherein the obtaining unit, the conversion unit, and the first correction unit operate in response to the receiving unit receiving the divided image.

2. The information processing apparatus according to claim 1, wherein
the predetermined threshold is smaller than the color difference between the first color and the second color.

3. The information processing apparatus according to claim 1, wherein
the predetermined threshold is 2.0 in Euclidean distance ΔE.

4. The information processing apparatus according to claim 2, wherein
the first color and the second color are colors expressed in any color space among CIE-L*a*b*, RGB, HLS, and HSV.

5. The information processing apparatus according to claim 1, wherein
the second color gamut is a color reproduction gamut for printing by an image forming apparatus.

6. The information processing apparatus according to claim 1, wherein
the fifth color is a color calculated based on the third color, the fourth color, and a color difference between the first color and the second color.

7. The information processing apparatus according to claim 6, wherein
the fifth color is a color obtained by correcting a lightness of the third color based on the color difference between the first color and the second color.

8. The information processing apparatus according to claim 7, wherein
the fifth color is a color obtained by setting the lightness of the third color to be a value obtained by adding the color difference between the first color and the second color to a lightness of the fourth color.

9. The information processing apparatus according to claim 6, wherein
the fifth color is a color obtained by mapping, in the second color gamut, a color obtained by setting a lightness of the third color to be a value obtained by adding the color difference between the first color and the second color to a lightness of the fourth color.

10. The information processing apparatus according to claim 6, wherein
the first correction unit corrects the conversion parameter such that a sixth color different from the first color and the second color and included in the first divided image is converted into a seventh color defined in the second color gamut, and
the seventh color is a color calculated based on the third color, the fourth color, and an eighth color, which is a color for when the sixth color is converted according to the first color conversion processing before correction of the conversion parameter.

11. The information processing apparatus according to claim 6, wherein
the second color is a color with the highest chroma among colors included in the first divided image.

12. The information processing apparatus according to claim 11, wherein
the first color is a color with the greatest lightness or a color with the least lightness among colors included in the first divided image.

13. The information processing apparatus according to claim 6, further comprising:
an estimation unit configured to estimate, among colors included in the first divided image, a color included in a second divided image to be received in succession to the first divided image,
wherein the second color is a color estimated to be a color included in the second divided image.

14. The information processing apparatus according to claim 13, wherein
the second color is a color included in a boundary portion, adjacent to the second divided image, of the first divided image.

15. The information processing apparatus according to claim 14, wherein
the second divided image is a divided image received subsequent to the first divided image, and
the second color is a color included in a boundary portion, adjacent to a third divided image received immediately prior to the first divided image, of the first divided image among colors included in the boundary portion, adjacent to the second divided image, of the first divided image.

16. The information processing apparatus according to claim 1, further comprising:
a grouping unit configured to group colors included in the divided image according to a hue range,
wherein the color information of the first color and the color information of the second color is color information of a hue range according to which grouping has been performed by the grouping unit.

17. The information processing apparatus according to claim 16, further comprising:
a second determination unit configured to determine whether two colors are recognized to be the same color based on a hue range,
wherein the grouping unit groups colors determined to be the same color by the second determination unit.

18. The information processing apparatus according to claim 17, wherein
the second determination unit recognizes colors in a hue range from 30 degrees to 60 degrees as the same color.

19. The information processing apparatus according to claim 1, further comprising:
a second correction unit configured to correct a correction amount of the conversion parameter by the first correction unit based on a ratio of a total number of combinations of colors included in the first divided image and the number of combinations of colors whose color difference after conversion according to the first color conversion processing is smaller than the predetermined threshold and which are included in the first divided image.

20. The information processing apparatus according to claim 1, wherein
the receiving unit receives a second divided image transmitted subsequent to the first divided image,
the obtaining unit obtains, from the second divided image, the color information of the first color and color information of a ninth color defined in the first color gamut and different from the second color,
the conversion unit performs the first color conversion processing for converting the first color into the third color defined in the second color gamut different from the first color gamut and converting the ninth color into a tenth color defined in the second color gamut, and
the first correction unit, in a case where a color difference between the third color and the tenth color is smaller than a threshold, correct a conversion parameter for the first color conversion processing such that a color difference between a color obtained by converting the ninth color into a color defined in the second color gamut and the third color is greater than the color difference between the third color and the tenth color.

21. The information processing apparatus according to claim 20, wherein
the first color is a color included in common between the first divided image and the second divided image.

22. The information processing apparatus according to claim 21, wherein
the first color is a color of an object that continues across a boundary portion between the first divided image and the second divided image.

23. The information processing apparatus according to claim 1, wherein
the receiving unit receives a second divided image transmitted subsequent to the first divided image, and
further comprising: a generation unit configured to generate a third conversion parameter used in the first color conversion processing for the second divided image based on a first conversion parameter, which is a conversion parameter corrected by the first correction unit based on color information in the first divided image, and a second conversion parameter, which is a conversion parameter corrected by the first correction unit based on color information in the second divided image.

24. The information processing apparatus according to claim 23, wherein
the generation unit generates the third conversion parameter such that a color after conversion in which the third conversion parameter is used is determined based on a color after conversion in which the first conversion parameter is used and a color after conversion in which the second conversion parameter is used.

25. The information processing apparatus according to claim 24, wherein
the generation unit generates the third conversion parameter such that a twelfth color obtained by converting an eleventh color in a first pixel position of the second divided image using the third conversion parameter is a color obtained by weighting, using weights set for a respective pixel position of the second divided image, and adding a thirteenth color obtained by converting the eleventh color using the first conversion parameter and a fourteenth color obtained by converting the eleventh color using the second conversion parameter.

26. The information processing apparatus according to claim 25, wherein
the weights are set for each pixel position of the second divided image such that a weight for the fourteenth color in the weighting and adding increases as a distance from a boundary portion between the first divided image and the second divided image increases.

27. An information processing method comprising:
receiving, from an apparatus configured to sequentially transmit respective divided images into which an image has been divided, a divided image;
obtaining, from a first divided image received by the receiving unit, color information of a first color defined in a first color gamut and color information of a second color defined in the first color gamut;
performing first color conversion processing for converting the first color into a third color defined in a second color gamut different from the first color gamut and converting the second color into a fourth color defined in the second color gamut; and
correcting, in a case where a color difference between the third color and the fourth color is smaller than a predetermined threshold, the conversion parameter for the first color conversion processing such that a color difference between a fifth color obtained by converting the first color into a color defined in the second color gamut and the fourth color is greater than the color difference between the third color and the fourth color,
wherein the obtaining process, the conversion process, and the first correction process are operated in response to the divided image is received.

28. A non-transitory computer-readable storage medium storing a program which, when executed by a computer comprising a processor and memory, makes the computer function as:
a receiving unit configured to receive, from an apparatus configured to sequentially transmit respective divided images into which an image has been divided, a divided image;
an obtaining unit configured to obtain, from a first divided image received by the receiving unit, color information of a first color defined in a first color gamut and color information of a second color defined in the first color gamut;
a conversion unit configured to perform first color conversion processing for converting the first color into a third color defined in a second color gamut different from the first color gamut and converting the second color into a fourth color defined in the second color gamut; and
a first correction unit configured to, in a case where a color difference between the third color and the fourth color is smaller than a predetermined threshold, correct the conversion parameter for the first color conversion processing such that a color difference between a fifth color obtained by converting the first color into a color defined in the second color gamut and the fourth color is greater than the color difference between the third color and the fourth color,
wherein the obtaining unit, the conversion unit, and the first correction unit operate in response to the receiving unit receiving the divided image.
